(19) United States
(12) Patent Application Publication
(10) Pub. No.: US 2012/0002050 A1
(43) Pub. Date: Jan. 5, 2012

(54) IMAGE DISPLAY SYSTEM

(75) Inventors: Susumu TANIGUCHI, Kobe-shi (JP); Masahiro YAMADA, Kobe-shi (JP)

(73) Assignee: FUJITSU TEN LIMITED, KOBE-SHI (JP)

(21) Appl. No.: 13/109,336

(22) Filed: May 17, 2011

(30) Foreign Application Priority Data
Jun. 30, 2010 (JP) 2010-148800

(51) Int. Cl. H04N 7/18

(52) U.S. Cl. 348/148; 348/E07.085

(57) ABSTRACT

An image display system includes a plurality of light sources respectively illuminating a plurality of divided regions. A user can change each of a plurality of light-amount parameters respectively specifying an amount of light to be output by each of the plurality of light sources by an operation on a change screen. Therefore, the user can illuminate each of the plurality of divided regions with an amount of light that he/she desires. As a result, the user can illuminate and definitely identify a subject difficult for the user to see and a subject to which the user needs to pay attention.

### BACKGROUND OF THE INVENTION

1. Field of the Invention

The invention relates to a technology that displays images to show surroundings of a vehicle.

2. Description of the Background Art

An image display system for installation in a vehicle, such as a car, which displays, on an in-vehicle display, images of surroundings of the vehicle shot with a camera mounted on the vehicle, is conventionally known. By using the image display system, a driver can understand the surroundings of the vehicle in substantially real time.

For example, a region outside a front fender of the vehicle, which is an opposite side to a driver seat, is often a blind spot for a driver. Therefore, it is difficult for the driver to grasp a clearance between the vehicle body and an obstacle. On the other hand, when the image display system is used, an on-vehicle camera shoots images showing the region outside the front fender and the images are displayed on an in-vehicle display. As a result, the driver can easily see the clearance between the obstacle and the vehicle body on the opposite side of the driver seat, for example, when closely pulling over to the roadside.

In a dark surrounding environment, such as at night, there is a case where the images showing the surroundings of the vehicle cannot be displayed with enough brightness because light exposure is insufficient for such an image display system to shoot images. Therefore, it is proposed to illuminate a region to be shot with the camera by providing auxiliary light for assisting in shooting images in order to ensure enough brightness as the images when the surrounding environment is relatively dark.

Recently, an image display system is proposed that generates a composite image showing the surroundings of the vehicle viewed from a virtual viewpoint, such as a point directly above the vehicle and a point behind the vehicle, by using a plurality of shot images acquired by shooting the surroundings of the vehicle with on-vehicle cameras, and that displays the composite image on a display. The image display system is capable of displaying an image showing the entire surroundings of the vehicle on the display.

Even when such an image display system is used, it is desirable to illuminate the surroundings of the vehicle when a surrounding environment is relatively dark. As a region displayable on an image display system becomes larger, a region to be illuminated by an auxiliary light in a relatively dark surrounding environment becomes larger. For example, it is required to illuminate a relatively large range of a side region of the vehicle from a forward area to a backward area of the vehicle, by an auxiliary light.

When the region to be illuminated is larger as cited earlier, there is a higher possibility that the region to be illuminated includes both an easily-recognizable bright subject and a difficult-to-recognize dark subject at the same time. In such circumstances, a user may desire to brightly illuminate and definitely identify the difficult-to-recognize dark subject.

However, a conventional image display system generally illuminates the region to be illuminated at a uniform amount of light by the auxiliary light. Therefore, even if the amount of light to illuminate an entire region is uniformly increased, the dark subject remains difficult to be recognized because a bright subject becomes brighter and exposure is controlled based on the bright subject. Moreover, if the amount of light for illumination is uniformly increased, a large amount of electricity is required because the region to be illuminated is large.

### SUMMARY OF THE INVENTION

According to one aspect of the invention, an image display system includes: a display that displays a vehicle surrounding image showing surroundings of a vehicle based on a shot image acquired by shooting the surroundings of the vehicle with a camera; a plurality of light sources that assist the camera in shooting by respectively illuminating a plurality of divided regions into which a region of the surroundings of the vehicle is divided; and a controller that, (i) based on input from a user, individually changes each of a plurality of parameters respectively specifying an amount of light to be output by each of the plurality of light sources, and (ii) adjusts the amount of light output by each of the plurality of light sources based on the plurality of parameters.

Since the amount of light output by each of the plurality of light sources can be individually changed based on the input from the user, the user can illuminate each of the plurality of divided regions around the vehicle with a desired amount of light. As a result, the user can clearly identify a subject difficult for the user to see and a subject to which the user needs to pay attention.

According to another aspect of the invention, the controller, based on the input from the user, selects one divided region from amongst the plurality of divided regions, and changes a parameter of the plurality of parameters for a light source illuminating the one divided region selected from amongst the plurality of light sources.

Since the user can change the parameter of the light source illuminating the one divided region selected, he/she can easily change an amount of light output by the light source illuminating his/her desired divided region.

According to another aspect of the invention, the image display system further includes an image generator that generates a composite image showing the surroundings of the vehicle viewed from a virtual viewpoint, based on a plurality of the shot images acquired by shooting the surroundings of the vehicle with a plurality of the cameras, and the vehicle surrounding image includes the composite image.

As a result, even when the display displays the composite image showing a relatively large range of the surroundings of the vehicle, the user can clearly identify the subject difficult for the user to see and the subject to which the user needs to pay attention.

According to another aspect of the invention, in response to changes of the plurality of parameters, the controller adjusts the amounts of light output by the plurality of light sources based on the plurality of parameters changed, and the display displays the vehicle surrounding image showing the surroundings of the vehicle shot in substantially real time using the adjusted amounts of the light output by the plurality of light sources, on a change screen used to change the plurality of parameters.

Since the display displays the vehicle surrounding image showing the surroundings of the vehicle shot in substantially real time using the adjusted amounts of the light output by the plurality of light sources, on the change screen used to change the parameters, the user can confirm brightness of each of the plurality of divided regions in substantially real time when changing amounts of light output by the plurality of light sources.

Therefore, the object of the invention is to illuminate each of the plurality of regions of the surroundings of the vehicle with light in an amount desired by the user.

These and other objects, features, aspects and advantages of the invention will become more apparent from the following detailed description of the invention when taken in conjunction with the accompanying drawings.

### BRIEF DESCRIPTION OF THE DRAWINGS

FIG. 1 is a block diagram showing a configuration of an image display system;

FIG. 2 shows locations of on-vehicle cameras disposed on a vehicle;

FIG. 3 shows a configuration of a left lighting part;

FIG. 4 shows a positional relationship between optical axes of the left lighting part and the vehicle;

FIG. 5 shows a positional relationship between the optical axes of the left lighting part and the vehicle;

FIG. 6 shows a configuration relating to adjustment of amounts of light to be output by light sources;

FIG. 7 explains a method for generating a composite image;

FIG. 8 shows transition of operation modes in a first embodiment;

FIG. 9 shows an example screen displayed in an entire downward view mode;

FIG. 10 shows an example screen displayed in a behind downward view mode;

FIG. 11 shows an example screen displayed in a side mode;

FIG. 12 is a flow diagram showing an operational process relating to illumination in an image display mode in the first embodiment;

FIG. 13 shows an example change screen for changing a light-amount parameter;

FIG. 14 is a flow diagram showing an operational process in a light-amount setting mode;

FIG. 15 shows an example warning displayed;

FIG. 16 shows an example change screen for changing the light-amount parameter;

FIG. 17 shows an example change screen for changing the light-amount parameter;

FIG. 18 shows an example light-amount setting data in a second embodiment;

FIG. 19 shows a flow diagram showing an operational process relating to illumination in an image display mode in the second embodiment;

FIG. 20 shows transition of a screen in the image display mode;

FIG. 21 shows an example change screen for changing a light-amount parameter;

FIG. 22 shows transition of operation modes in the second embodiment;

FIG. 23 shows a transition to an individual setting mode;

FIG. 24 shows a transition to an individual setting mode;

FIG. 25 shows a transition to an individual setting mode;

FIG. 26 shows an example light-amount setting data in a third embodiment;

FIG. 27 shows an example change screen in the third embodiment; and

FIG. 28 shows another example of a configuration relating to adjustment of amounts of light to be output by light sources.

### DESCRIPTION OF THE EMBODIMENTS

Hereinbelow, embodiments of the invention are described with reference to the drawings.

### 1. First Embodiment

### 1-1. System Configuration

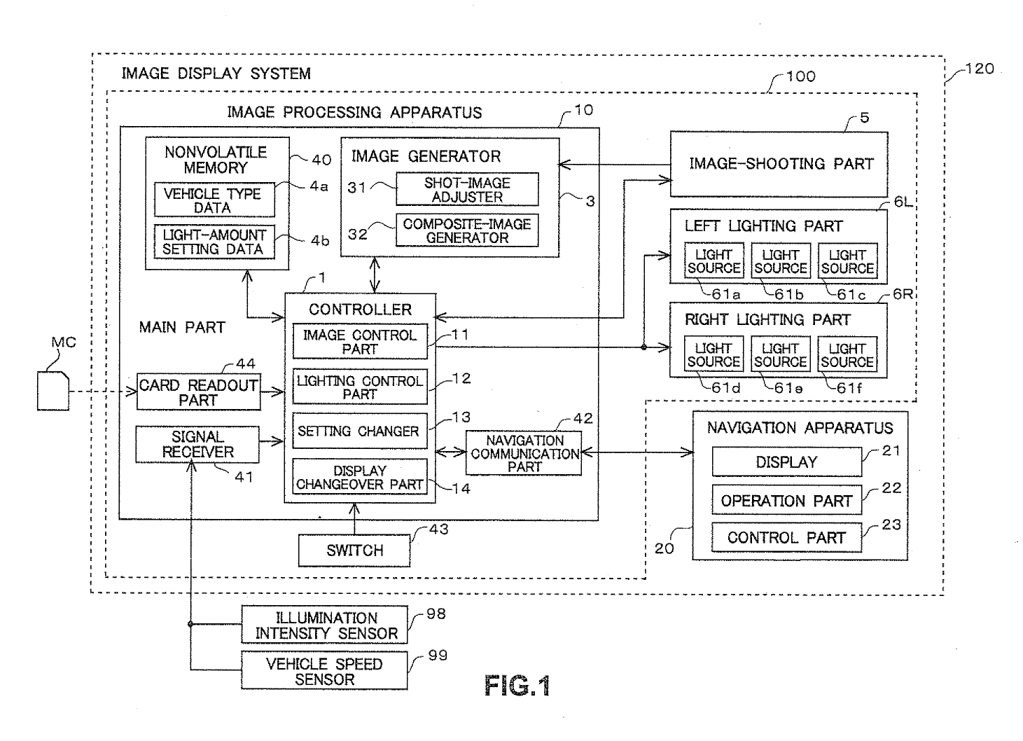

FIG. 1 is a block diagram showing a configuration of an image display system 120 that is a first embodiment of the invention. The image display system 120 is for installation on a vehicle (a car in this embodiment) and has functions of shooting surroundings of the vehicle, of generating an image and of displaying the image in a cabin of the vehicle. A user (mainly a driver) of the image display system 120 can grasp the surroundings of the vehicle in substantially real time, by using the image display system 120.

As shown in FIG. 1, the image display system 120 mainly includes an image processing apparatus 100 that generates a vehicle surrounding image showing the surroundings of the vehicle, and a navigation apparatus 20 that displays a variety of information for the user in the vehicle. The vehicle surrounding image generated by the image processing apparatus 100 is displayed on the navigation apparatus 20.

The navigation apparatus 20 provides navigation guidance for the user. The navigation apparatus 20 includes a display 21, such as a liquid crystal panel, having a touch-panel function, an operation part 22 including a hardware switch and the like, with which the user operates the navigation apparatus 20, and a control part 23 that controls the whole navigation apparatus 20. The navigation apparatus 20 is disposed in or on an instrument panel, etc. of the vehicle, such that a screen of the display 21 can be viewed from the user. Each of user operations is received by the operation part 22, or the display 21 serving as a touch panel. The control part 23 is a computer including a CPU, a RAM, a ROM, etc., and various functions including a navigation function are implemented by arithmetic processing performed by the CPU in accordance with a predetermined program.

The navigation apparatus 20 is communicably connected to the image processing apparatus 100. Therefore, the navigation apparatus 20 can transmit and receive various control signals to/from the image processing apparatus 100, and can receive an image generated by the image processing apparatus 100. The display 21 normally displays an image based on a function only of the navigation apparatus 20 under control of the control part 23. However, under a predetermined condition, the vehicle surrounding image generated by the image processing apparatus 100 is displayed. As a result, the navigation apparatus 20 functions also as a display apparatus that receives and displays the vehicle surrounding image generated by the image processing apparatus 100.

The image processing apparatus 100 includes a main part 10 and an image-shooting part 5. The main part 10 is an ECU (Electronic Control Unit) having a function of generating the vehicle surrounding image and is disposed at a predetermined location in the vehicle. The image-shooting part 5 includes a plurality of on-vehicle cameras and shoots the surroundings of the vehicle. The image processing apparatus 100 functions as an image generation apparatus that generates a composite image viewed from a virtual viewpoint based on shot images acquired by the image-shooting part 5 by shooting the surroundings of the vehicle.

Moreover, the image processing apparatus 100 includes a left lighting part 6L and a right lighting part 6R that assist in shooting by the image-shooting part 5, and functions as an on-vehicle lighting apparatus that provides illumination for assisting in shooting by the image-shooting part 5. The left lighting part 6L includes three light sources 61a, 61b and 61c. The right lighting part 6R also includes three light sources 61d, 61e, and 61f. Each of these six light sources 61a to 61f emits auxiliary light that assists in shooting by the image-shooting part 5. When the surrounding environment of the vehicle is dark, e.g., at night, the left lighting part 6L and the right lighting part 6R illuminate the surroundings of the vehicle.

The plurality of on-vehicle cameras of the image-shooting part 5 and the plurality of light sources 61a to 61f of the left lighting part 6L and the right lighting part 6R are disposed at appropriate locations on the vehicle, separately from the main part 10. The details of the disposition will be described later.

The main part 10 of the image processing apparatus 100 mainly includes a controller 1 that controls the whole image processing apparatus 100, an image generator 3 that generates an image for display by processing the shot images acquired by the image-shooting part 5, and a navigation communication part 42 that communicates with the navigation apparatus 20.

Each of user commands received by the operation part 22 or the display 21 of the navigation apparatus 20 is received as a control signal by the navigation communication part 42 and is input into the controller 1. Moreover, the image processing apparatus 100 includes a switch 43 that receives a user command to change a displayed content. A signal representing a user operation is also input into the controller 1 from the switch 43. As a result, the image processing apparatus 100 is capable of functioning in response to the user operation made with the navigation apparatus 20 or with the switch 43. The switch 43 is disposed at an appropriate location in the vehicle, separately from the main part 10 for easy operation by the user.

The image generator 3 is a hardware circuitry capable of various types of image processing, and includes a shot-image adjuster 31 and a composite-image generator 32 as main functions.

The shot-image adjuster 31 adjusts the shot image acquired by the image-shooting part 5, for display. Concretely, the shot-image adjuster 31 performs the image processing such as correction of distortion, scaling, clipping, of the shot image.

Based on the shot images acquired by the plurality of on-vehicle cameras of the image-shooting part 5, the composite-image generator 32 generates the composite image showing the surroundings of the vehicle viewed from an arbitrary virtual viewpoint around or over the vehicle. A method where the composite-image generator 32 generates the composite image will be described later.

The shot image adjusted by the shot-image adjuster 31 and the composite image generated by the composite-image generator 32 are further adjusted to be displayed. Then, the images to be displayed are output to the navigation apparatus 20 by the navigation communication part 42. As a result, the vehicle surrounding image including at least a part of a region around the vehicle is displayed, as a subject image, on the display 21 of the navigation apparatus 20. In this embodiment, the term “vehicle surrounding image” refers to an image showing at least a part of surroundings of a vehicle and is a concept including both a shot image and a composite image.

The controller 1 is a computer including a CPU, a RAM, a ROM, etc. Various control functions are implemented by arithmetic processing performed by the CPU in accordance with a predetermined program. An image control part 11, a lighting control part 12, a setting changer 13, and a display changeover part 14 shown in the drawing represent a part of the functions implemented by the controller 1 in such a manner.

The image control part 11 controls the image processing performed by the image generator 3. For example, the image control part 11 specifies various parameters, such as a light-amount parameter, required for generation of the composite image by the composite-image generator 32.

The lighting control part 12 implements control relating to illumination by the left lighting part 6L and the right lighting part 6R, such as adjustment of an amount of light (light amount) of each of the left lighting part 6L and the right lighting part 6R. The image display system 120 is provided with six light-amount parameters respectively specifying light amounts of the six light sources 61a to 61f. The lighting control part 12 adjusts each of the light amounts of the six light sources 61a to 61f individually, based on the six light-amount parameters.

The setting changer 13 changes the six light-amount parameters respectively corresponding to the six light sources 61a to 61f. The setting changer 13 is capable of changing each of the six light-amount parameters, based on a user operation.

The display changeover part 14 changes a type of the vehicle surrounding image to be displayed on the display 21, in response to the user operation.

Moreover, the main part 10 of the image processing apparatus 100 further includes a nonvolatile memory 40, a card readout part 44, and a signal receiver 41, all of which are connected to the controller 1.

Examples of the nonvolatile memory 40 are a standby RAM (a RAM directly connected to a battery included in the vehicle) and a flash memory that are capable of retaining a stored content even while the image display system 120 is turned off. A vehicle type data 4a and a light-amount setting data 4b, etc. are stored in the nonvolatile memory 40.

The vehicle type data 4a is data according to type of the vehicle and includes, e.g., a variety of sizes of the vehicle. Moreover, the light-amount setting data 4b is table data including the six light-amount parameters specifying light amounts of the six light sources 61a to 61f.

The card readout part 44 reads contents of a memory card MC that is a portable recording medium. The card readout part 44 includes a memory card slot into/from which the memory card MC can be inserted and removed, and reads out data stored in the memory card MC in the memory card slot. The data being read out by the card readout part 44 is input into the controller 1.

An example of the memory card MC is a flash memory capable of storing a variety of data. The image display system 120 is capable of using the variety of data stored in the memory card MC. For example, by reading out a program stored in the memory card MC a program (firmware) for implementing a function of the controller 1 can be updated. Moreover, vehicle type data for a vehicle type, stored in the memory card MC, which is different from the vehicle type data 4a stored in the nonvolatile memory 40 is read out from the memory card MC and then stored in the nonvolatile memory 40. As a result, the image display system 120 can be changed to accommodate to a different type of vehicle.

The signal receiver 41 receives signals from various apparatuses mounted on the vehicle. A signal from the outside of the image display system 120 is input into the controller 1 via the signal receiver 41. Concretely, the signals representing a variety of information from an illumination intensity sensor 98, a vehicle speed sensor 99, etc. are input into the controller 1.

The illumination intensity sensor 98 is disposed at a substantially upper center of a front windshield or on a dashboard to detect an illumination intensity indicating brightness of a surrounding environment of the vehicle. The illumination intensity as a detection result is input into the controller 1 from the illumination intensity sensor 98. Moreover, a running speed (km/h) of a vehicle 9 at a moment is input into the controller 1 from the vehicle speed sensor 99.

### 1-2. Image-Shooting Part and Lighting Part

Next described are details of the image-shooting part 5, the left lighting part 6L, and the right lighting part 6R of the image processing apparatus 100. Each of the image-shooting part 5, the left lighting part 6L, and the right lighting part 6R is electrically connected to the controller 1 and functions based on a signal from the controller 1.

The image-shooting part 5 includes four on-vehicle cameras of a front camera, a rear camera, side cameras on the left and the right sides. Each of the on-vehicle cameras includes an image sensor, such as a CCD and a CMOS, and shoots an image electronically. Moreover, each of the on-vehicle cameras implements exposure control of adjusting exposure time and an aperture based on brightness of an image acquired by the image sensor, to ensure appropriate brightness of the image.

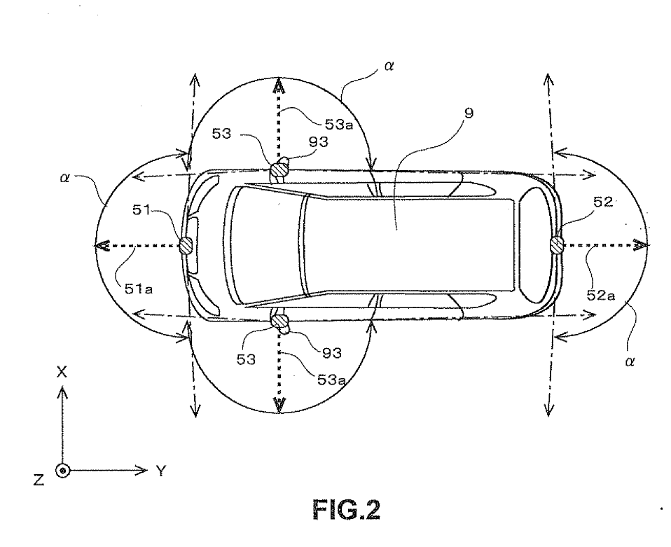

FIG. 2 shows the locations where the four on-vehicle cameras are disposed on the vehicle 9. In addition, a direction in the drawings is arbitrarily indicated by three dimensional Cartesian coordinates using an X-axis, Y-axis and Z-axis in the following description. Each of the X-, Y- and Z-axes is relatively fixed to the vehicle 9. A width direction of the vehicle 9 is referred to as an X-axis direction, a direction in which the vehicle 9 travels (a longitudinal direction of the vehicle 9) is referred to as a Y-axis direction and a vertical direction of the vehicle 9 is referred to as a Z-axis direction. For convenience, a right side of the vehicle 9 is referred to as +X side, a backside of the vehicle 9 is referred to as +Y side, and an upper side of the vehicle 9 is referred to as +Z side.

A front camera 51 is disposed in a proximity of an installation location of a license plate at a front edge of the vehicle 9, with an optical axis 51a of the front camera 51 directed in the direction in which the vehicle 9 travels (−Y side on the Y-axis in a planar view). A rear camera 52 is disposed in a proximity of an installation location of a license plate at a rear edge of the vehicle 9, with an optical axis 52a of the rear camera 52 directed in a direction opposite to the direction in which the vehicle 9 travels (+Y side on the Y-axis in the planar view). Moreover, side cameras 53 are respectively disposed on left and right door mirrors 93, with optical axes 53a of the side cameras 53 respectively directed outward along the width direction of the vehicle 9 (x-axis direction in the planar view). It is preferable that each of the front camera 51 and the rear camera 52 is installed at a substantial center between a right edge and a left edge of the vehicle 9. However, the front camera 51 or the rear camera 52 may be disposed at a location slightly right or left from the center.

Since each of these on-vehicle cameras 51, 52 and 53 is equipped with, e.g., a fish-eye lens, each of the on-vehicle cameras 51, 52 and 53 has an angle of view α of 180 degrees or more. Therefore, the surroundings entirely around the vehicle 9 can be shot by using the four on-vehicle cameras 51, 52 and 53.

Referring back to FIG. 1, the six light sources 61a to 61f included in the left lighting part 6L and the right lighting part 6R include, for example, LEDs that emit invisible near infrared light. Since the near infrared light is invisible to human beings, even when the light sources 61a to 61f illuminate the surroundings of the vehicle 9, the light has no influence on pedestrians and other people around the vehicle 9. On the other hand, the image sensors adopted for the on-vehicle cameras 51 to 53 can sense near infrared light. Therefore, when the surrounding environment of the vehicle 9 is relatively dark, an image showing the surroundings of the vehicle 9 can be acquired, without any influence on pedestrians and other people, by illuminating a region around the vehicle 9 with near infrared light output by the light sources 61a to 61f of the left lighting part 6L and the right lighting part 6R as auxiliary light.

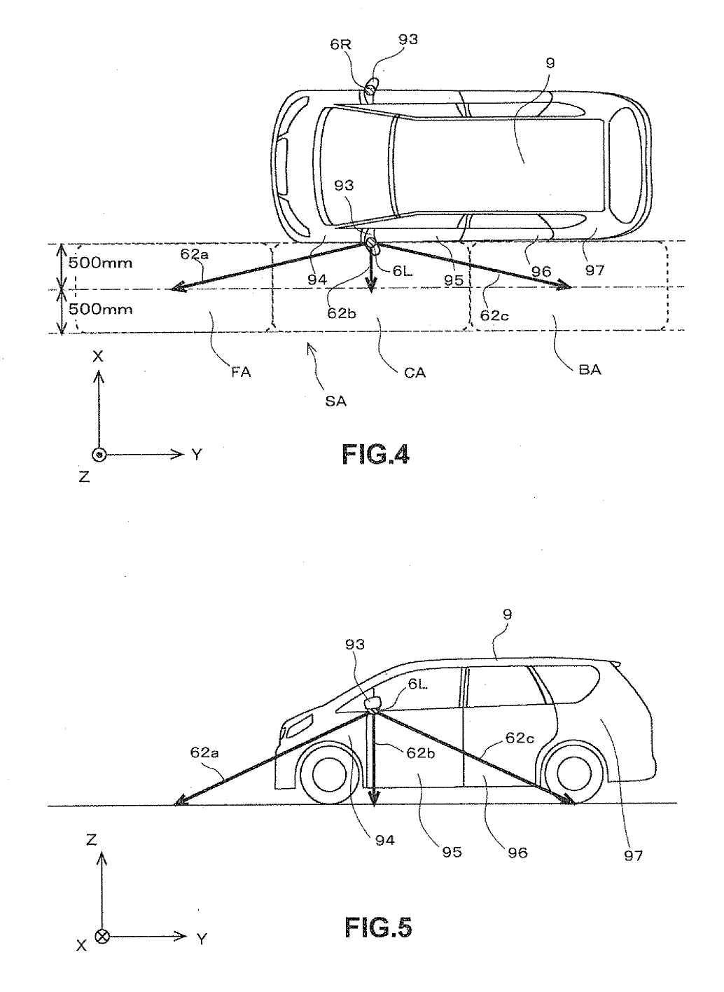

The left lighting part 6L is disposed on the door mirror 93 on a left side of the vehicle 9 and the right lighting part 6R is disposed on the door mirror 93 on a right side of the vehicle 9. (Refer to FIG. 4.) The left lighting part 6L illuminates a left lateral region of the vehicle 9, and the right lighting part 6R illuminates a right lateral region of the vehicle 9.

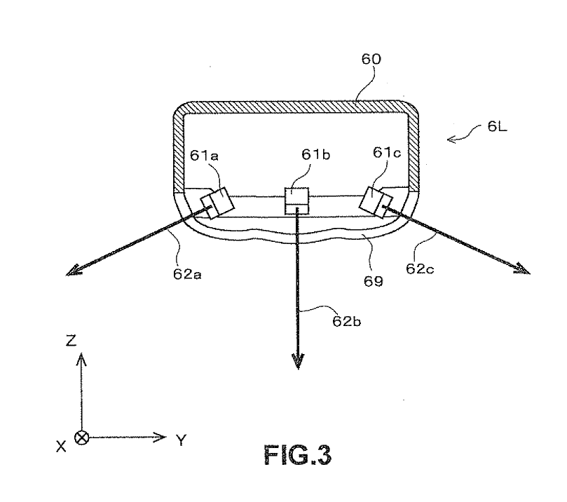

FIG. 3 is a sectional view in a YZ plan viewed from the left side (−X side) of the vehicle 9, showing a configuration of the left lighting part 6L. As shown in the drawing, the left lighting part 6L has a housing 60 in which three light sources 61a, 61b and 61c are housed.

Among the three light sources 61a to 61c, concretely, a front light source 61a illuminates mainly a forward region of the vehicle 9, a rear light source 61c illuminates mainly a backward region of the vehicle 9, and a center light source 61b illuminates mainly a region between the regions respectively illuminated by the front light source 61a and the rear light source 61c. The center light source 61b is disposed in a center portion of the housing 60. The front light source 61a and the rear light source 61c are disposed symmetrically with respect to a center of the housing 60. A transmissive member 69 which transmits near infrared light is adopted for a lower part of the housing 60 below the light sources 61a to 61c. As a result, the auxiliary light output by the light sources 61a to 61c can illuminate an outside of the housing 60.

Viewed from a horizontal direction (the x-axis direction) of the vehicle 9, a light axis 62b of the center light source 61b is along the vertical direction (the Z-axis direction), a light axis 62a of the front light source 61a is angled toward a front side (−Y side) of the vehicle 9, and a light axis 62c of the rear light source 61c is angled toward a rear side of the vehicle 9.

FIG. 4 and FIG. 5 shows a positional relationship between the vehicle 9 and the light axes 62a to 62c of the three light sources 61a to 61c of the left lighting part 6L. FIG. 4 is a top view (viewed from +Z side), and FIG. 5 is a side view (viewed from −X side).

As shown in these drawings, each of the light axes 62a, 62b and 62c of the three light sources 61a, 61b and 61c extends from the left lighting part 6L on the door mirror 93 to a position on a line 500 mm away from the lateral side of the vehicle 9 in the x-axis direction.

Each of these light axes 62a, 62b and 62c extends in a different direction from the other two axes. Concretely, in the planar view (refer to FIG. 4), the light axis 62b of the center light source 61b extends along the horizontal direction (the X-axis direction) of the vehicle 9, the light axis 62a of the front light source 61a is directed in a front direction (−Y side) of the vehicle 9, and the light axis 62c of the rear light source 61c is directed in a rear direction (+Y side) of the vehicle 9. Moreover, in the side view (refer to FIG. 5), the light axis 62b of the center light source 61b is directed along the vertical direction (the Z-axis direction). The light axis 62a of the front light source 61a is directed in the front direction (−Y side) of the vehicle 9. The light axis 62c of the rear light source 61c is directed in the rear direction (+Y side) of the vehicle 9. A direction of the light axis 62a of the front light source 61a is symmetrical to a direction to the light axis 62c of the rear light source 61c with respect to the light axis 62b of the center light source 61b.

Such disposition of the light axes 62a to 62c allows each of the three light sources 61a to 61c of the left lighting part 6L to respectively illuminate a part of a side region SA that is positioned outside the lateral side of the vehicle 9. The side region SA is fixed relative to the vehicle 9 and is defined as a predetermined particular region to be illuminated. The side region SA is a region having a length from approximately two meters ahead of a front end of the vehicle 9 to approximately a rear end of the vehicle 9 in the longitudinal direction (the Y-axis direction) of the vehicle 9 and having a width approximately up to one meter outward from the lateral side of the vehicle 9 in the horizontal direction (the X-axis direction).

The three light sources 61a, 61b and 61c respectively illuminate a plurality of divided regions FA, BA and CA into which the side region SA is divided. Concretely, the front light source 61a mainly illuminates the front divided region (hereinafter referred to as “front region”) FA, of the side region SA to be illuminated, that is a region forward of the front end of the vehicle 9. The rear light source 61c mainly illuminates the divided region (hereinafter referred to as “rear region”) BA, of the side region SA to be illuminated, that is an outer region of a vicinity of a rear door 96 and a rear fender 97 of the vehicle 9. The center light source 61b mainly illuminates the divided region (hereinafter referred to as “center region”) CA that is an outer region of a vicinity of a front fender 94 and a front door 95 of the vehicle 9. In other word, the center region CA is a region between the front region FA and the rear region BA, of the side region SA to be illuminated.

The configuration and the disposition only of the left lighting part 6L was described above. The right lighting part 6R is symmetrical to the left lighting part 6L in terms of configuration and disposition, with respect to a center in the horizontal direction of the vehicle 9. Therefore, like the left lighting part 6L, the right lighting part 6R illuminates a side region defined as the particular region on the right side of the vehicle 9. Moreover, the three light sources 61d, 61e and 61f of the right lighting part 6R respectively illuminate the plurality of divided regions (a front region, a center region and a rear region) into which the side region is divided.

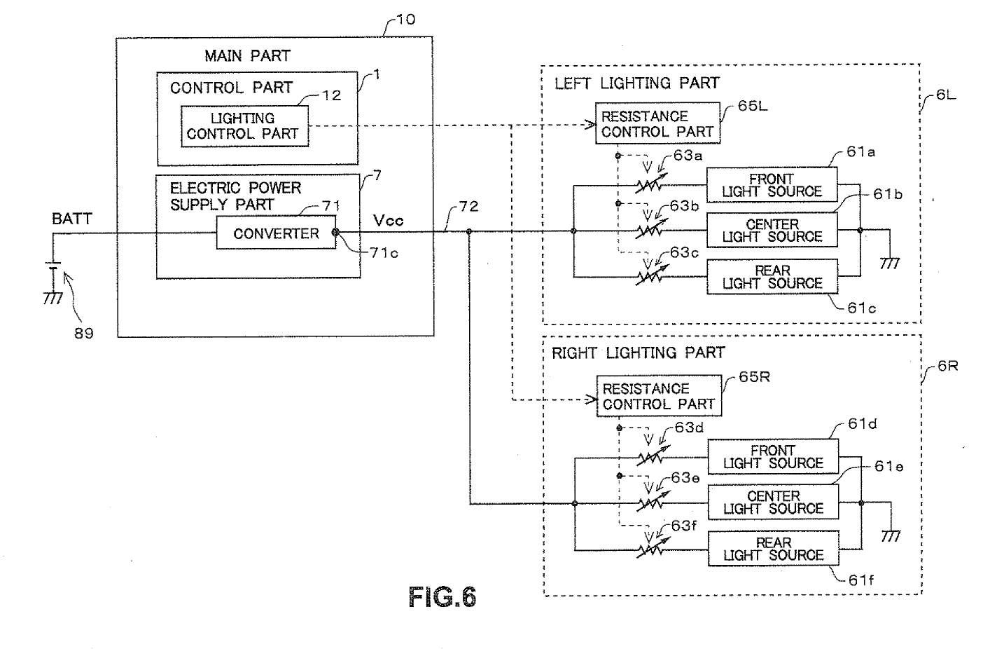

Each of the light amounts of the aforementioned six light sources 61a to 61f can be adjusted individually. FIG. 6 shows a configuration of the image display system 120, relating to the adjustment of the light amounts of the six light sources 61a to 61f.

The six light sources 61a to 61f are supplied with electric power from an electric power supply part 7 included in the main part 10. The electric power supply part 7 includes a DC-DC converter 71 (hereinafter referred to as “converter”) that converts a DC voltage. The converter 71 reduces a voltage BATT (e.g. 12.5 V) of a battery 89 provided in the vehicle 9, to a constant voltage Vcc (e.g. 6 V). As a result, a voltage of a power line 72 to which an output terminal 71c of the converter 71 is connected, is kept constant at the voltage Vcc.

The three light sources 61a, 61b and 61c of the left lighting part 6L are disposed in parallel to each other. The three light sources 61a, 61b and 61c are connected, on upstream sides, to the power line 72 through variable resistors 63a, 63b and 63c, and connected to ground on downstream sides, respectively. Likewise, the three light sources 61d, 61e and 61f of the right lighting part 6R are disposed in parallel to each other, respectively. The three light sources 61d, 61e and 61f are connected, on upstream sides, to the power line 72 respectively through variable resistors 63d, 63e and 63f, and are connected to ground on downstream sides.

Each of the light amounts of the light sources 61a to 61f individually depends on a value of a current flowing through each light source. Since the voltage of the power line 72 is constant, the light amounts of the light sources 61a to 61f can be individually changed by changing respective variable resistors 63a to 63f provided on the upstream sides of the individual light sources 61a to 61f. For example, since a current value increases when a resistance value of a variable resistor is decreased, a light amount output by a light source positioned on the downstream side of the variable resistor, is increased. Contrarily, when a resistance value of a variable resistor is increased, a light amount output by a light source positioned on the downstream side of the variable resistor, is reduced. Moreover, a circuit can be broken at each of the variable resistors. When the circuit is broken (a resistance value is changed to an infinite value), the current flow stops and the light amount output by the light source connected to the circuit becomes zero. In other words, the light source of the circuit is turned off.

The left lighting part 6L includes a resistance control part 65L capable of changing individually each of resistance values of the variable resistors 63a to 63c provided in the left lighting part 6L. Likewise, the right lighting part 6R includes a resistance control part 65R capable of changing individually each of resistance values of the variable resistors 63d to 63f provided in the right lighting part 6R. The resistance control parts 65L and 65R are also capable of breaking the circuit at each of the variable resistors 63a to 63f. By sending a signal to the resistance control parts 65L and 65R, the lighting control part 12 of the controller 1 included in the main part 10 is capable of adjusting the individual light amounts of six, in total, light sources 61a to 61f that are the three light sources 61a to 61c of the left lighting part 6L and the three light sources 61e to 61f of the right lighting part 6R.

However, an output capacity of the converter 71 has a limitation. The converter 71 is not capable of supplying electric power more than the rating of the converter 71. In other words, there is an upper limit to the current flowing through the output terminal 71c of the converter 71. All of the six light sources 61a to 61f are supplied with electric power via the common output terminal 71c of the converter 71. Therefore, all the currents flowing through the six light sources 61a to 61f flow into the output terminal 71c. As a result, there is an upper limit to a total amount of the currents through the six light sources 61a to 61f. In this embodiment, the upper limit of the total amount of the currents is, for example, 200 (mA).

As cited earlier, the individual light amounts of the light sources 61a to 61f depend on the individual values of the currents flowing through the light sources 61a to 61f. Therefore, there is an upper limit to a total light amount output by the six light sources 61a to 61f, based on the capacity of the converter 71. Hereinbelow, a specific light amount that is the upper limit based on the capacity of the converter 71 is referred to as “limit light amount.” The total light amounts of the six light sources 61a to 61f are adjusted not to exceed the limit light amount. The details will be described later.

### 1-3. Image Conversion Process

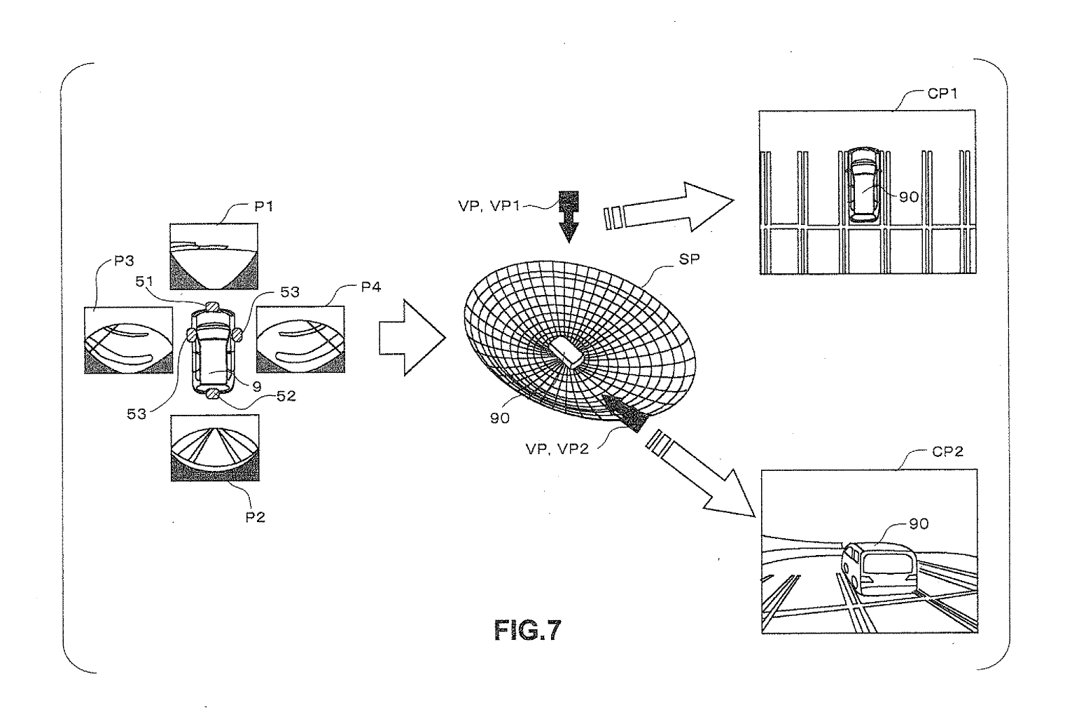

Next explained is a method where the composite-image generator 32 of the image generator 3 generates a composite image that shows the surroundings of the vehicle 9 viewed from an arbitrary virtual viewpoint, based on a plurality of shot images acquired by the image-shooting part 5. The vehicle type data 4a stored beforehand in the nonvolatile memory 40 is used to generate the composite image. FIG. 7 is a diagram for explaining the method for generating the composite image.

When the front camera 51, the rear camera 52 and the side cameras 53 of the image-shooting part 5 capture images simultaneously, four shot images P1 to P4 are acquired. The shot images P1 to P4 respectively show a region in front of the vehicle 9, a region behind the vehicle 9 and outer regions on the left side and on the right side of the vehicle 9. In other words, information showing the surroundings entirely around the vehicle 9 at a moment of shooting the images is included in the four shot images P1 to P4 acquired by the image-shooting part 5.

Then, each pixel of the four shot images P1 to P4 is projected onto a three-dimensional (3D) curved surface SP in virtual 3D space. The 3D curved surface SP is, for example, substantially hemispherical (bowl-shaped). The vehicle 9 is defined to be located in a center portion of the 3D curbed surface SP (a bottom of the bowl). A correspondence relation between positions of individual pixels included in the shot images P1 to P4 and positions of individual pixels included in the 3D curved surface SP is predetermined. Therefore, values of the individual pixels of the 3D curved surface SP can be determined based on the correspondence relation and values of the individual pixels included in the shot images P1 to P4.

The correspondence relation between the positions of the individual pixels included in the shot images P1 to P4 and the positions of the individual pixels included in the 3D curved surface SP depends on disposition (mutual distances, heights above the ground, and angles of light axes, etc.) of the four on-vehicle cameras 51, 52 and 53. Therefore, table data representing the correspondence relation is included in the vehicle type data 4a stored in the nonvolatile memory 40.

Moreover, polygon data representing a vehicle shape and a vehicle size included in the vehicle type data 4a is used to virtually configure a vehicle image 90 that is a polygon model showing a 3D shape of the vehicle 9. The vehicle image 90 configured is disposed in the center portion of the substantially hemispherical shape where the vehicle 9 is defined to be located, in the 3D space having the 3D curved surface SP.

Moreover, a virtual viewpoint VP is set in the 3D space having the 3D curved surface SP, by the controller 1. The virtual viewpoint VP is defined by a viewpoint location and a direction of a visual field, and is set at an arbitrary viewpoint location equivalent to the surroundings of the vehicle 9 in the 3D space, having the visual field directed in an arbitrary direction.

In accordance with the virtual viewpoint VP being set, a necessary region of the 3D curved surface SP is clipped as an image. A relation between the virtual viewpoint VP and the necessary region of the 3D curved surface SP is predetermined, and is stored beforehand in the nonvolatile memory 40, etc. as table data. Meanwhile, in accordance with the virtual viewpoint VP being set, the vehicle image 90 converted into two dimensions (2D), as a result of rendering of the vehicle image 90 configured by polygons, is superimposed on the image clipped. Accordingly, the composite image showing the vehicle 9 and the surroundings of the vehicle 9 viewed from the arbitrary virtual viewpoint is generated.

For example, when a virtual viewpoint VP1 is set at a viewpoint location directly above a substantially center portion of the vehicle 9, having the visual field directed in a substantially straight downward direction, a composite image CP1 is generated to show the vehicle 9 (actually the vehicle image 90) and the surroundings of the vehicle 9 viewed downward from approximately directly above the vehicle 9. Moreover, as shown in the drawing, when a virtual viewpoint VP2 is set at a viewpoint location on the left side behind the vehicle 9, having the visual field directed in a substantially frontward direction, a composite image CP2 is generated to show a panoramic view of the vehicle 9 (actually the vehicle image 90) and the surroundings of the vehicle 9 viewed from the left side behind the vehicle 9.

Actually, the values of all the pixels of the 3D curved surface SP do not have to be determined when the composite image is generated. A process of the generation can be improved by determining, based on the shot images P1 to P4, values of pixels only of a necessary region in accordance with the virtual viewpoint VP being set.

### 1-4. Operation Mode

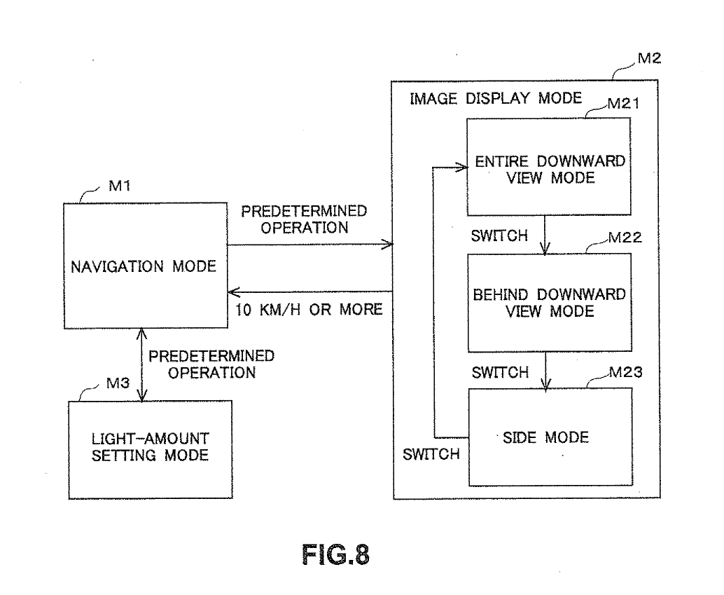

Next, operation modes of the image display system 120 are explained. FIG. 8 shows transitions of the operation modes of the image display system 120. The image display system 120 has mainly three operation modes that are a navigation mode M1, an image display mode M2 and a light-amount setting mode M3. Each of these operation modes can be switched to one of the others by control of the controller 1 in accordance with a user operation or a running state of the vehicle.

The navigation mode M1 is an operation mode in which a map image, etc. for the navigation guidance is displayed on the display 21 by a function of the navigation apparatus 20. In the navigation mode M1, a variety of information is displayed by the function only of the navigation apparatus 20, without using a function of the image processing apparatus 100.

On the other hand, the image display mode M2 is an operation mode in which at least one vehicle surrounding image from a shot image and a composite image is displayed on the display 21, by using the image processing apparatus 100. As a result, in the image display mode M2, the surroundings of the vehicle 9 are displayed to a user substantially in real time.

Moreover, the light-amount setting mode M3 is an operation mode in which light amounts of the six light sources 61a to 61f of the left lighting parts 6L and 6R are set. In the light-amount setting mode M3, the user can set individually each of the light amounts of the six light sources 61a to 61f, individually.

The image display system 120 starts in the navigation mode M1 when being turned on. Then the operation mode is switched to the image display mode M2 when a predetermined user operation is performed in the navigation mode M1. Moreover, when a vehicle running speed is, for example, 10 km/h or more in the image display mode M2, the operation mode is switched to the navigation mode M1 in order to have the driver concentrating on driving in a case where the vehicle 9 travels at a relatively high speed. In addition, when a menu screen is called up in the navigation mode M1 and a predetermined operation is performed, the operation mode is switched to the light-amount setting mode M3.

There are three display modes of which display styles are different from each other, in the image display mode M2. When the user presses the switch 43, one of the display modes is changed to one of the others by control of the display changeover part 14. The three display modes are, concretely, an entire downward view mode M21, a behind downward view mode M22, and a side mode M23. In the three display modes, types of the vehicle surrounding image to be displayed are different from each other. In other words, a region around the vehicle viewed from a different viewpoint is displayed in each of the display modes.

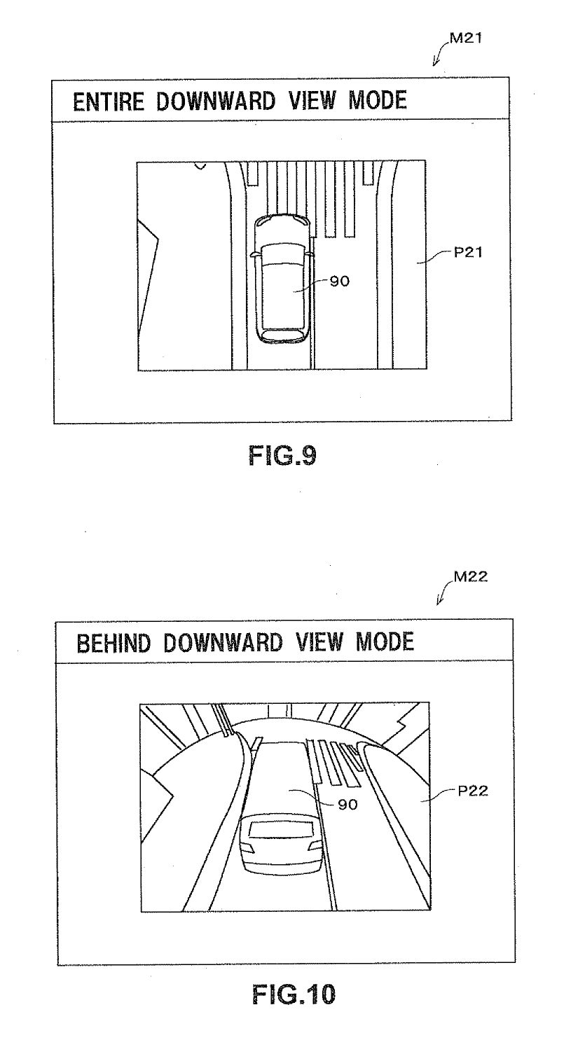

As shown in FIG. 9, the entire downward view mode M21 is a display mode that displays, on the display 21, a screen including an entire downward image P21 that is a composite image showing the surroundings of the vehicle viewed from a virtual viewpoint directly above the vehicle. The entire downward image P21 includes a region entirely around the vehicle as a subject image. Therefore, the entire downward view mode M21 can be used widely in various occasions during driving regardless of moving forward or moving backward.

As shown in FIG. 10, the behind downward view mode M22 is a display mode that displays, on the display 21, a screen including a behind downward image P22 that is a composite image showing the surroundings of the vehicle viewed from a virtual viewpoint behind the vehicle. The behind downward image P22 includes regions on the left side and the right side of the vehicle as a subject image. The virtual viewpoint of the behind downward image P22 is located more behind than the virtual viewpoint of the entire downward image P21. As a result, a region behind the vehicle in the image P22 is smaller, but the side regions of the vehicle can be easily checked. Therefore, the behind downward view mode M22 can be effectively used for checking a clearance between a vehicle coming from an opposite direction and the vehicle 9 when the vehicles pass each other.

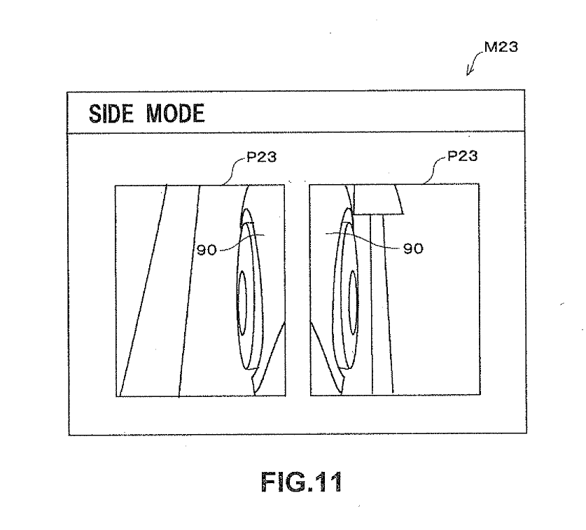

As shown in FIG. 11, the side mode M23 is a display mode that displays, on the display 21, a screen including two side images P23 acquired with the side cameras 53 on the left side and right side of the vehicle 9 and placed side by side. The side images P23 are not composite images but images shot with the side cameras 53. The positions of viewpoints of the side images P23 are the same as the positions of viewpoints of the side cameras 53. Each of the side images P23 only includes a region outside the front fender of the vehicle, as a subject image. The region is often a blind spot from the driver seat. Therefore, the side mode M23 can be used for checking a region near the vehicle when the driver pulls the vehicle 9 over closely to a roadside.

As described above, in the image display mode M2, a plurality of types of the vehicle surrounding images individually viewed from different viewpoints, can be displayed. In other words, the plurality of types of the vehicle surrounding images including different regions around the vehicle 9 from one another, as a subject image, can be displayed. In response to a press of the switch 43, the display changeover part 14 changes the types of the vehicle surrounding images. As a result, the user can check the surroundings of the vehicle 9 from a desired viewpoint.

### 1-5. Illumination Operation in the Image Display Mode

As described above, in the image display mode M2, the vehicle surrounding image acquired by the image-shooting part 5 is displayed. However, when the surrounding environment is dark, e.g., at night, there is a case where a light exposure is not sufficient to capture an image and brightness enough to show the surroundings of the vehicle 9 cannot be ensured. Therefore, when the surrounding environment is relatively dark in the image display mode M2, the left lighting part 6L and the right lighting part 6R emit the auxiliary light to assist in shooting the images.

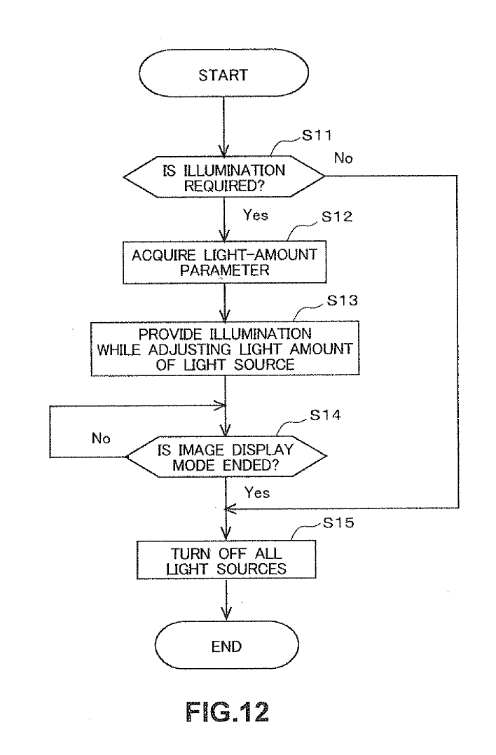

FIG. 12 is a flow diagram showing an operational process relating to illumination in the image display mode M2. The process is implemented by control of the lighting control part 12 unless otherwise specified. The process shown in FIG. 12 starts in response to a change to the image display mode M2.

First, it is determined whether or not the illumination by the left lighting part 6L and the right lighting part 6R is necessary (a step S11). Concretely, the necessity is determined by whether or not the illumination intensity of ambient brightness around the vehicle 9 that is input from the illumination intensity sensor 98, is lower than a predetermined threshold. However, the necessity of the illumination may be determined based on average brightness of a shot image acquired by the image-shooting part 5.

When the illumination intensity is higher than the predetermined threshold (No in the step S11), it is determined that the illumination is not required and the process ends with all the light sources 61a to 61f turned off (a step S15).

On the other hand, when the illumination intensity is lower than the predetermined threshold value (Yes in the step S11), it is determined that the illumination is required. In this case, next the light-amount setting data 4b is read out from the nonvolatile memory 40 and the six light-amount parameters are acquired from the light-amount setting data 4b (a step S12).

As described above, the six light-amount parameters respectively specify the light amounts of the six light sources 61a to 61f. Each of the six light-amount parameters is represented by an integer from “zero (0)” to “twenty (20).” Values computed by multiplying the individual six light-amount parameters by ten are determined as values (mA) of currents to be flowed through the light sources corresponding to the individual light parameters. In other words, when one of the light-amount parameters is “one (1),” the value of the current to be flowed through the light source corresponding to the light-amount parameter is 10 (mA). When one of the light-amount parameters is “three (3),” the value of the current to be flowed through the light source corresponding to the light-amount parameter is 30 (mA).

When the six light-amount parameters are acquired, the lighting control part 12 sends signals, based on each of the six light-amount parameters, to the resistance control parts 65L and 65R of the left lighting part 6L and the right lighting part 6R, respectively. In response, the two resistance control parts 65L and 65R change the resistance values of the variable resistors 63a to 63f of the upstream side of the light sources 61a to 61f. As a result, the values of the currents flowing through the six light sources 61a to 61f are individually adjusted to the values indicated by the six light-amount parameters respectively corresponding to the light sources. Therefore, the light amounts of the six light sources 61a to 61f are individually adjusted. Accordingly, the light sources 61a to 61f are turned on while the light amounts thereof are adjusted (a step S13).

Such an illumination state of the light sources 61a to 61f is maintained until the image display mode M2 is ended (a step S14). When the image display mode is changed from the image display mode M2 to, for example, the navigation mode M1 (Yes in the step S14), all the light sources 61a to 61f are turned off (the step S15) and the process ends.

### 1-6. Light-Amount Setting Mode

As described above, the light amounts of the six light sources 61a to 61f are individually adjusted based on the six light-amount parameters, in the image display mode M2. The user can arbitrarily change the six light-amount parameters that respectively specify the amounts of the light sources 61a to 61f, in the light-amount setting mode M3. Accordingly, the image display system 120 allows each of a plurality of divided regions (the front region, the rear region and side regions) defined in regions outside lateral sides of the vehicle 9 to be illuminated with a light amount that the user desires.

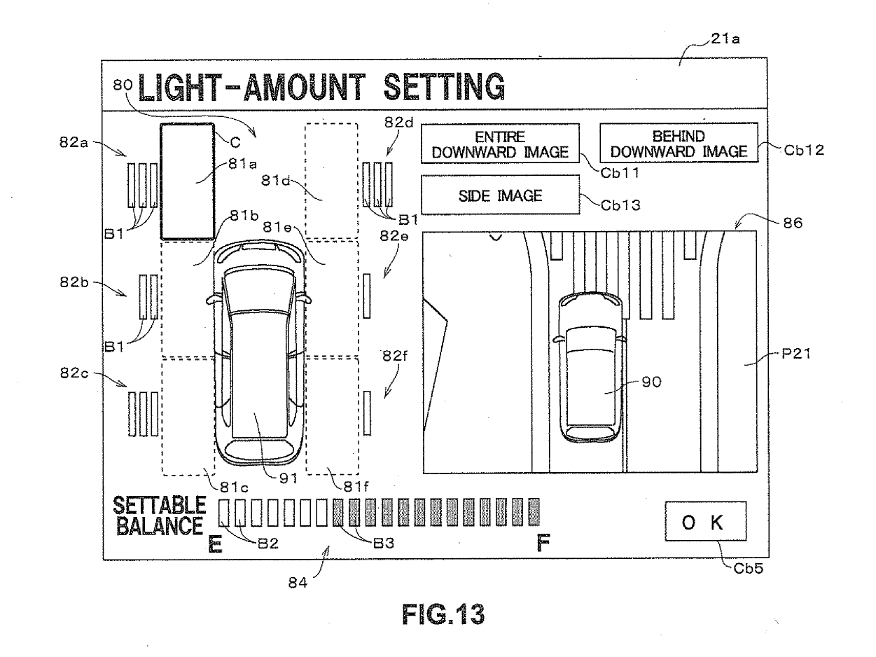

FIG. 13 shows an example of a change screen 21a to be displayed on the display 21 to change the six light-amount parameters in the light-amount setting mode M3.

As shown in the drawing, a light amount-setting region 80 that shows a setting status of the six light-amount parameters of the six light sources 61a to 61f, is provided on a left side of the change screen 21a. A vehicle illustration 91 that shows a shape of the vehicle 9 viewed from directly above the vehicle 9 is displayed in the light amount-setting region 80. Moreover, on the left and right sides of the vehicle illustration 91, six display divided regions 81a to 81f are provided, corresponding to the six divided regions (the front region FA, the center region CA, and the rear region BA shown in FIG. 4). Positions of the actual divided regions corresponding to the display divided regions 81a to 81f, are displayed relative to the vehicle 9, based on positions of the six display divided regions 81a to 81f relative to the vehicle illustration 91.

Actual positions of the divided regions vary from one type of the vehicle 9 to another because the actual positions depend on disposition (height above the ground, lengthwise position etc.) of the light sources on the vehicle 9. Therefore, the vehicle type data 4a includes adjustment data for adjusting the display divided regions 81a to 81f. Positions of the display divided regions 81a to 81f are adjusted based on the adjustment data, depending on the type of the vehicle 9 in which the image display system 120 is mounted. As a result, the positions of the divided regions relative to the vehicle 9 can be appropriately displayed, depending on the type of the vehicle 9.

The user can select one from amongst the six display divided regions 81a to 81f by touching the one display divided region. A cursor C is provided on the one being selected from amongst the six display divided regions 81a to 81f. Selecting one from amongst the six display divided regions 81a to 81f is substantially equivalent to selecting a corresponding divided region. For example, selecting the display divided region 80a located on an upper left portion of the change screen 21a, as shown in the drawing, is equivalent to selecting the front region FA on the left side of the vehicle 9.

Parameter display regions 82a to 82f are respectively provided outside the six display divided regions 81a to 81f. The parameter display regions 82a to 82f respectively correspond to actual divided regions represented by the six display divided regions 81a to 81f located on inner sides of the parameter display regions 82a to 82f. Moreover, in each of the parameter display regions 82a to 82f, a level-setting bar set B1 indicates a value of the light-amount parameter specifying the light amount to be output by the corresponding one of the light sources 61a to 61f for illuminating the corresponding divided region.

One bar of the level-setting bar set 131 means “one (1)” of the light-amount parameter. For example, three bars of the level-setting bar set B1 are shown in the parameter display region 82a outside the display divided region 81a on an upper left portion of FIG. 13. The three bars mean that the light-amount parameter of the light source 61a for illuminating the front region FA on the left side of the vehicle 9 is “three (3).”

As described above, the values of the light-amount parameters corresponding to the individual divided regions are displayed in the light amount-set region 80. The values of the light-amount parameters can be changed by a user operation. When changing a value of one of the six light-amount parameters, the user selects one of the divided regions by touching desired one of the six display divided regions 81a to 81f. While the one divided region is being selected, the user can increase or decrease a light-amount parameter of a light source that illuminates the one divided region selected by a predetermined user operation via the operation part 22 of the navigation apparatus 20. At the same time, the number of bars of the level-setting bar set B1 increases or decreases in each of the parameter display regions 82a to 82f in accordance with an increase or a decrease of a value of each of the six light-amount parameters. As a result, the user can easily adjust the light-amount parameter of the light source that illuminates the desired one of the divided regions, to a desired value.

Any method can be adopted for changing the values of the light-amount parameters after one from amongst the display divided regions 81a to 81f is selected. For example, each of the values of the light-amount parameters may be increased or decreased by touching one of the six display divided regions 81a to 81f or by touching one of the parameter display regions 82a to 82f.

Moreover, a balance display region 84 is disposed under the light amount-setting region 80. As described earlier, there is the upper limit to the total light amount output by the six light sources 61a to 61f, and the total amount is required to be below the upper limit. In the balance display region 84, an indication is displayed that indicates an amount by which the light-amount parameters can be changed until the total light amount to be output by the six light sources 61a to 61f reaches the upper limit. Concretely, an increasable amount of the light-amount parameters is shown by the number of white bars B2. Moreover, a total amount being set for the six light-amount parameters is shown by the number of gray bars B3. One of the white bars B2 or the gray bars B3 is equivalent to “one (1)” of each of the six light-amount parameters.

In this embodiment, the total amount of the six light-amount parameters is required to be “20” or below “20” to keep the total light amount output by the six light sources 61a to 61f equal to or below the upper limit of light amount. The number of the white bars B2 and the gray bars B3 are 20 in total, and the number of the gray bars B3 is the same as a total number of bars of the level-setting bar sets B1 shown in the parameter display regions 82a to 82f. An example shown in FIG. 13 shows the total amount of the light-amount parameters already being set is “13” and the user can increase the six light-amount parameters by seven (7) in total until the total amount to be output by the six light sources 61a to 61f reaches the upper limit of light amount. The user can understand an amount by which the light-amount parameters can be increased until the converter 71 reaches the upper limit of electric power supply capability, by looking at such display.

Moreover, an image display region 86 for displaying the vehicle surrounding image is disposed on a right side of the change screen 21a. In the image display region 86, the vehicle surrounding image shot by the image-shooting part 5 at a time is displayed. In other words, the vehicle surrounding image shows the surroundings of the vehicle 9 in substantially real time.

Furthermore, three command buttons Cb11, Cb12 and Cb13 are disposed above the image display region 86. The three command buttons Cb11 to Cb13 respectively correspond to the entire downward image P21, the behind downward image P22 and the side image P23. When the user touches one of the three command buttons Cb11 to Cb13, the display changeover part 14 changes types of the vehicle surrounding image displayed in the image display region 86.

In addition, an OK button Cb5 is disposed at a lower right portion of the image display region 86. By a touch to the OK button Cb5, a changed value of the six light-amount parameters is determined and stored in the nonvolatile memory 40 as the light-amount setting data 4b.

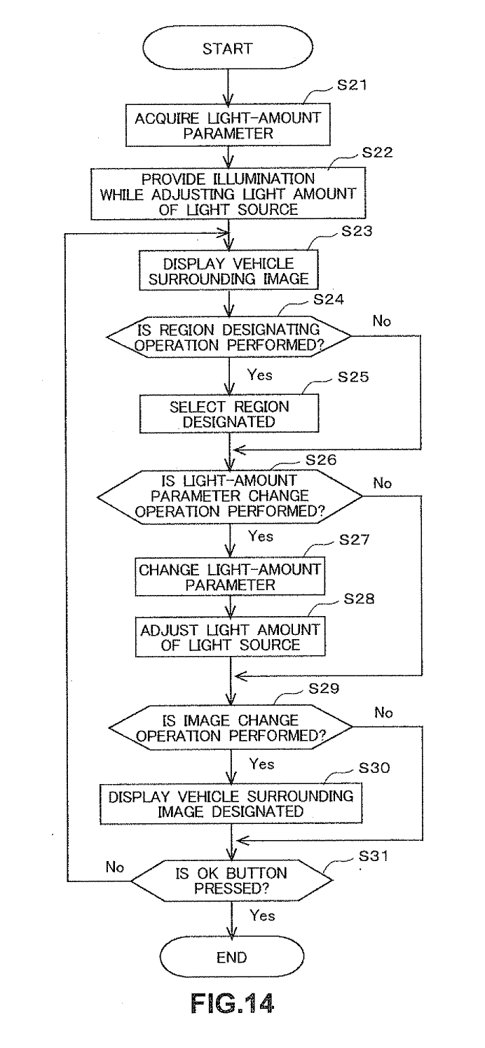

FIG. 14 is a flow diagram showing an operational process in the light-amount setting mode M3. The process described below is implemented by control of the setting changer 13, unless otherwise specified. The setting changer 13 appropriately works with the image control part 11 and the lighting control part 12. The process shown in FIG. 14 starts in response to a change to the light-amount setting mode M3.

The light sources 61a to 61f are turned on by control of the lighting control part 12. In other words, the light-amount setting data 4b is read out from the nonvolatile memory 40 by the lighting control part 12, and the six light-amount parameters are acquired from the light-amount setting data 4b (a step S21). Then based on the six light-amount parameters, signals are sent from the lighting control part 12 to the resistance control parts 65L and 65R of the left lighting parts 6L and 6R. As a result, the light amounts of the six light sources 61a to 61f are individually adjusted based on the six light-amount parameters. Accordingly, the light sources 61a to 61f are turned on while the light amounts thereof are adjusted individually (a step S22).

Next, the surroundings of the vehicle is shot by the image-shooting part 5, and the vehicle surrounding image (the entire downward image P21 at this moment) is generated by the image generator 3 based on the shot images acquired. On the display 21, the change screen 21a as shown in FIG. 13 is displayed and the vehicle surrounding image generated is displayed in the image display region 86 (a step S23).

After that, the image display system 120 goes into a user operation waiting state in which the image display system 120 waits for a user operation. In the user operation waiting state, a series of the operational process in which the surroundings of the vehicle 9 is shot by the image-shooting part 5, the vehicle surrounding image is generated based on the shot images acquired and then the vehicle surrounding image generated is displayed in the image display region 86, is repeated (No in a step S31, the step S23). As a result, the surroundings of the vehicle 9 are shown to the user in substantially real time. In other words, the user can understand a level on which each of the divided regions around the vehicle 9 is illuminated, in substantially real time.

In the user operation waiting state, when an operation for designating one of the divided regions, in other words, a user operation of touching one of the six display divided regions 81a to 81f, is performed (Yes in a step S24), the cursor C moves to the one touched of the display divided regions. The one divided region designated is selected as a divided region of which the light-amount parameter is changed (a step S25).

In the user operation waiting state, when an operation for changing one of the light-amount parameters, in other words, a predetermined operation via the operation part 22 of the navigation apparatus 20 is performed (Yes in a step S26), the one light-amount parameter of a divided region to be changed is changed (a step S27) based on the operation.

However, when the total light amount output by the six light sources 61a to 61f would exceed the upper limit of light amount due to a change of one of the six light-amount parameters specified, the user operation is not received and the one light-amount parameter is not changed. As a result, the light amounts of the light sources 61a to 61f can be changed within an appropriate range in which the converter 71 can supply electric power.

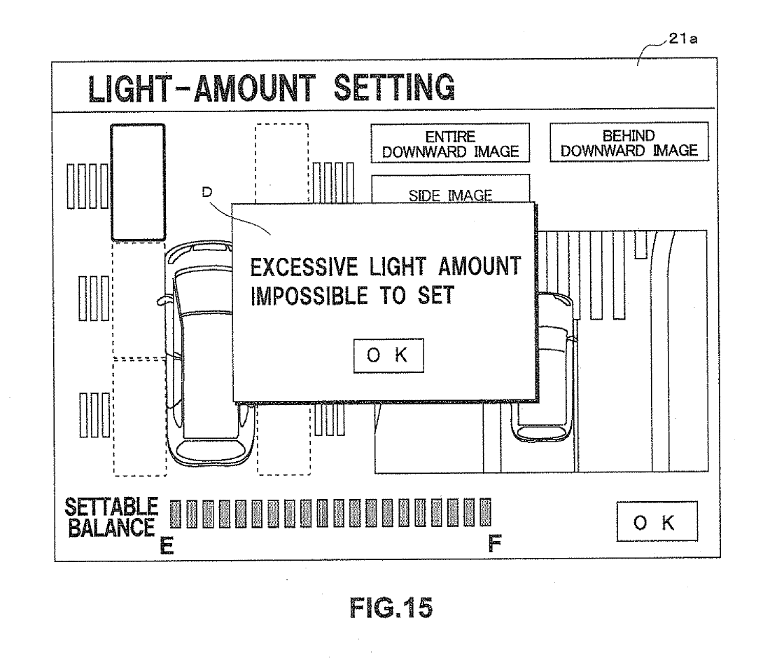

When the user operation is not received as described earlier, the display 21 displays, as shown in FIG. 15, a warning dialog box D indicating that the total light amount to be output by the six light sources 61a to 61f would exceed the upper limit of light amount. In other words, the display 21 functions as an alarm that provides the user with a warning. Accordingly, the user can explicitly understand the limit of electric power supply of the converter 71. The user may be informed of the warning in a different method, such as by a warning beep sound.

When one of the light-amount parameters is normally changed, in response to the change of the one light-amount parameter, the light amount output by the light source corresponding to the one light-amount parameter is actually adjusted by control of the lighting control part 12, based on the one light-amount parameter changed (a step S28). The adjustment of the light-amount causes a change of the brightness of the divided region, around the vehicle 9, illuminated by the light source corresponding to the one light-amount parameter. Such a change in brightness can be confirmed with the vehicle surrounding image displayed in the image display region 86. In other words, the user can understand a result of the change of the one light-amount parameter in substantially real time, by looking at the vehicle surrounding image. Therefore, the user can easily change each of the light-amount parameters, such that desired one of the divided regions around the vehicle 9 is illuminated with desired brightness.

Moreover, in the user operation waiting state, when an operation for changing the type of the vehicle surrounding image to be displayed, in other words, a user operation of touching one out of the three command buttons Cb11 to Cb13 is performed (Yes in a step S29), the display changeover part 14 displays the vehicle surrounding image of the type corresponding to the one button designated from amongst the three command buttons Cb11 to Cb13, in the image display region 86. In other words, the vehicle surrounding image of a type corresponding to the one of the three command buttons Cb11 to Cb13 is generated by the image generator 3 and the vehicle surrounding image generated is displayed in the image display region 86 (a step S30).

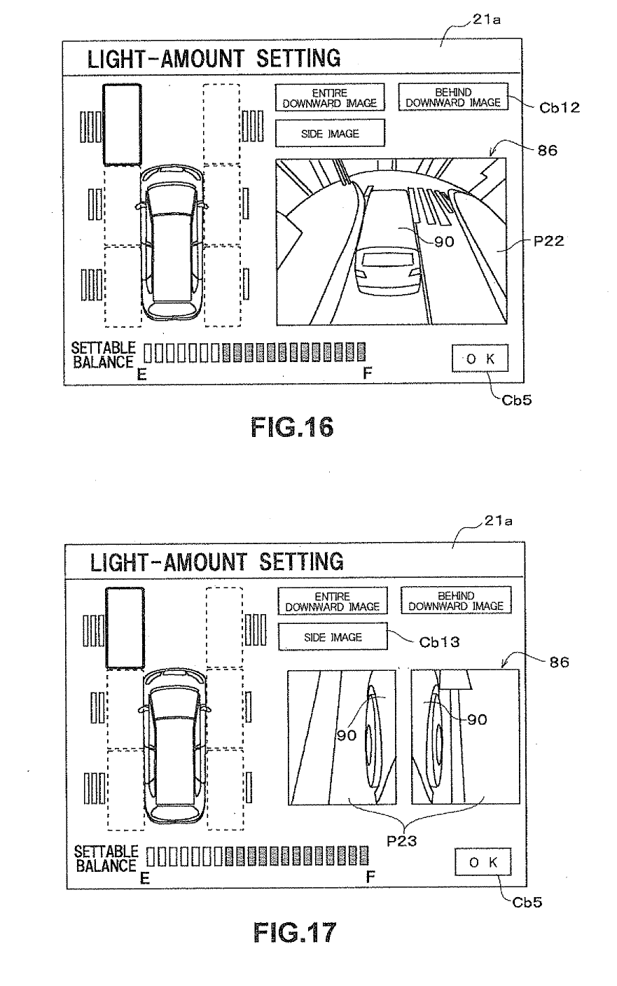

When the user touches the entire downward image button Cb11, the entire downward image P21 is displayed in the image display region 86, as shown in FIG. 13. Moreover, when the user touches the behind downward image button Cb12, the behind downward image P22 is displayed in the image display region 86, as shown in FIG. 16. Furthermore, when the user touches the side image button Cb13, the side image P23 is displayed in the image display region 86, as shown in FIG. 17. After that, the process in which the vehicle surrounding image according to a type changed is displayed in the image display region 86, is repeated (No in the step S31, the step S23). As described above, it is possible to change the type of the vehicle surrounding image and to display the vehicle surrounding image of the type changed by the user operation. Therefore, the user can confirm the brightness of each of the divided regions from a desired viewpoint.

Moreover, in the user operation waiting state, when the user touches the OK button Cb5 (Yes in the step S31), the six light-amount parameters being set in the light amount-setting region 80 at the moment are determined and stored in the nonvolatile memory 40 as the light-amount setting data 4b. Then the light-amount setting mode M3 ends.

As described above, the image display system 120 in this embodiment includes the plurality of light sources 61a to 61f that individually illuminate the plurality of divided regions. The user can change each of the plurality of light-amount parameters respectively specifying the plurality of light sources 61a to 61f by performing an operation using the change screen 21a. Therefore, the user can illuminate each of the plurality of divided regions with light amount desired by the user. As a result, the user can illuminate and distinctly identify a subject difficult to be seen from the user or a subject to which the user needs to pay attention.

Moreover, the vehicle surrounding image showing the surroundings of the vehicle is displayed in substantially real time on the change screen 21a that is used for changing the light-amount parameters. Therefore, the user can confirm, in substantially real time, the brightness of the individual divided regions in a case where the individual light sources 61a to 61f are changed.

### 2. Second Embodiment

### 2-1. Outline

Next, a second embodiment is described. In the first embodiment, a same light-amount parameter is used regardless of the type of the vehicle surrounding image to be displayed. However, in the second embodiment, light-amount parameters according to a type of a vehicle surrounding image are used. A structure and an operational process of an image display system 120 in the second embodiment is almost the same as the structure and the operational process in the first embodiment. Therefore, hereinbelow, a difference between the first and the second embodiments is described.

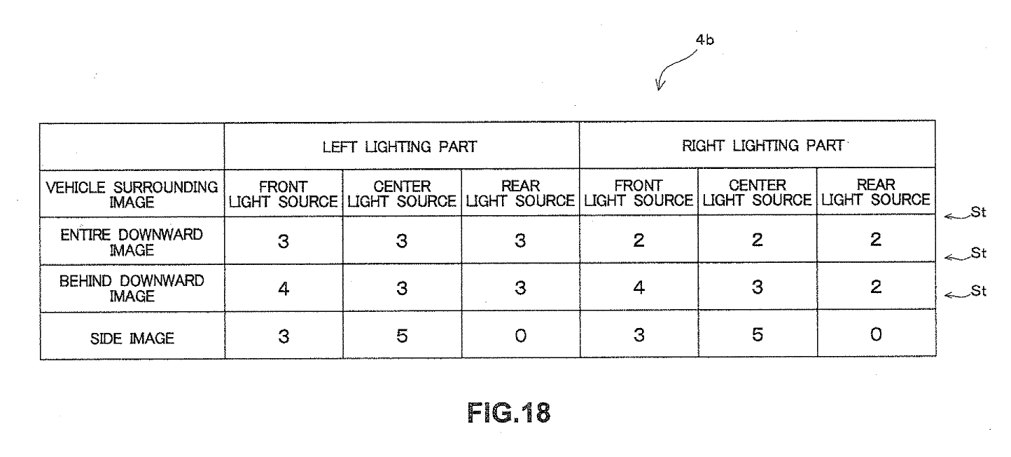

FIG. 18 shows an example of light-amount setting data 4b in the second embodiment. As described earlier, six light-amount parameters are provided individually corresponding to a front light source 61a, a center light source 61b and a rear light source 61c of a left lighting part 6L and a front light source 61d, a center light source 61e and a rear light source 61f of a right lighting part 6R. In the second embodiment, the six light-amount parameters are collectively defined as a parameter set St. As shown in FIG. 18, the parameter set St is prepared for each type of the vehicle surrounding image and is included in the light-amount setting data 4b.

In an image display mode M2, the parameter set St corresponding to a type of the vehicle surrounding image to be displayed on the display 21, is acquired from the light-amount setting data 4b, and light amounts of the six light sources 61a to 61f are adjusted based on the parameter set St.

### 2-2. Illuminating Operational Process in the Image Display Mode

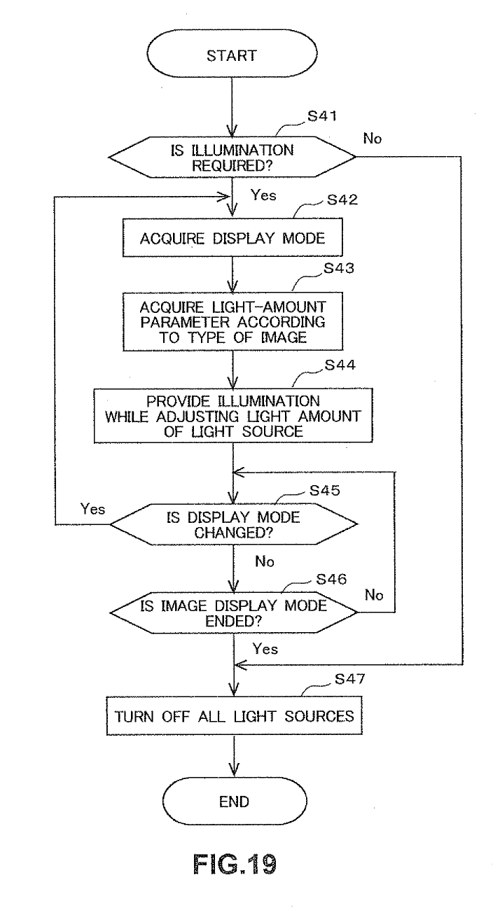

FIG. 19 is a flow diagram showing an operational process relating to illumination in the image display mode M2 in the second embodiment.

First, it is determined whether or not the illumination by the left lighting part 6L and the right lighting part 6R is required (a step S41). When the illumination is not required (No in the step S41), the process ends with all the light sources 61a to 61f turned off (a step S47).

On the other hand, when the illumination is required (Yes in the step S41), first, a present display mode is acquired (a step S42). Next, the parameter set St corresponding to a type of the vehicle surrounding image to be displayed on the display 21 in the mode, is acquired from the light-amount setting data 4b in the nonvolatile memory 40. In other words, the parameter set St corresponding to an entire downward image P21 is acquired in an entire downward view mode M21, and the parameter set St corresponding to a behind downward image P22 is acquired in a behind downward view mode M22, and the parameter set St corresponding to a side image P23, is acquired in a side mode M23 (a step S43).

When the parameter set St is acquired, the light amounts of the six light sources 61a to 61f are individually adjusted by the control of the lighting control part 12, based on the six light-amount parameters included in the parameter set St. Therefore, each of the light sources 61a to 61f is turned on while the light amount output by the each light source is adjusted (a step S44). As a result, each of the light amounts of the six light sources 61a to 61f can be adjusted to an optimum light amount for a viewpoint of the vehicle surrounding image being displayed.

As described above, in the image display mode M2, a press of the switch 43 allows the display mode to be changed. When the display mode is changed, the parameter set St is required to be changed because a display changeover part 14 changes types of the vehicle surrounding image displayed on the display 21.

Therefore, when the display mode is changed (Yes at a step S45), accordingly, the process returns to the step S42. Then the display mode is reacquired and the parameter set St corresponding to a type of the vehicle surrounding image changed is acquired (the step 43). Moreover, the light amounts of the six light sources 61a to 61f are individually adjusted by the control of the lighting control part 12, based on the six light-amount parameters included in the parameter set St (the step S44).

In response to the change of the vehicle surrounding image to be displayed on the display 21, the parameter set St corresponding to the type of the vehicle surrounding image changed is acquired, and the light amounts of the six light sources 61a to 61f are individually adjusted based on the parameter set St. As a result, immediately after the change of the vehicle surrounding image, each of the light amounts of the six light sources 61a to 61f can be adjusted to an optimum light amount for a viewpoint of the vehicle surrounding image being displayed.

When an operation mode is changed from the image display mode M2 to, for example, a navigation mode M1 (Yes in a step S46), all the light sources 61a to 61f are turned off (a step S47), and the process ends.

### 2-3. Light-Amount Setting Mode

Also in the second embodiment, the light-amount parameters can be changed in a light-amount setting mode M3. Since there are the plural parameter sets St, a user first designates a type of the vehicle surrounding image of which the parameter set St he/she desires to change and then changes the six light-amount parameters included in the parameter set St corresponding to the type of the vehicle surrounding image designated.

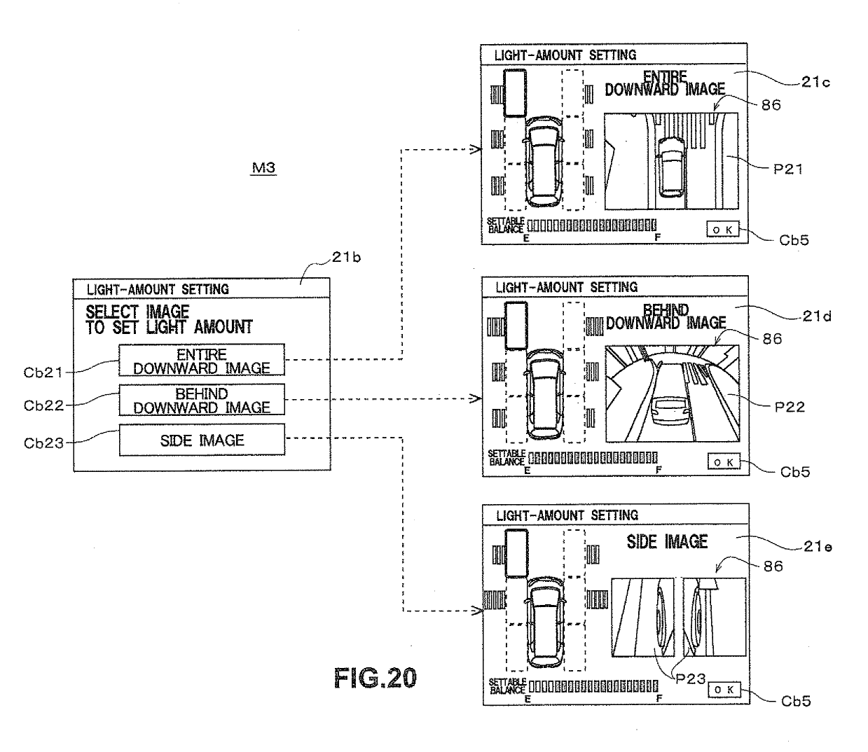

FIG. 20 shows transitions of a screen to be displayed on the display 21 in the light-amount setting mode M3. In the light-amount setting mode M3, first, an image-designating screen 21b on which the user designates a type of the vehicle surrounding image is displayed. Three command buttons Cb21, Cb22, and Cb23 are provided on the image-designating screen 21b. These three command buttons Cb21 to Cb23 are individually corresponding to the entire downward image P21, the behind downward image P22 and the side image P23. The user can designate a type of the vehicle surrounding image by touching one of the command buttons Cb21 to Cb23.

When the user touches the entire downward image button Cb21, the display 21 displays a change screen 21c for changing the six light-amount parameters included in the parameter set St corresponding to the entire downward image P21. When the user touches the behind downward image button Cb22, the display 21 displays a change screen 21d for changing the six light-amount parameters included in the parameter set St corresponding to the behind downward image P22. Moreover, when the user touches the side image button Cb23, the display 21 displays a change screen 21e for changing the six light-amount parameters included in the parameter set St corresponding to the side image P23.

The user can change the six light-amount parameters included in the parameter set St corresponding to the type of the vehicle surrounding image that he/she designates, on the change screen 21c, 21d, and 21e. Styles of the change screens 21c, 21d, and 21e are substantially the same as the change screen 21a shown in FIG. 13 but are partially different.

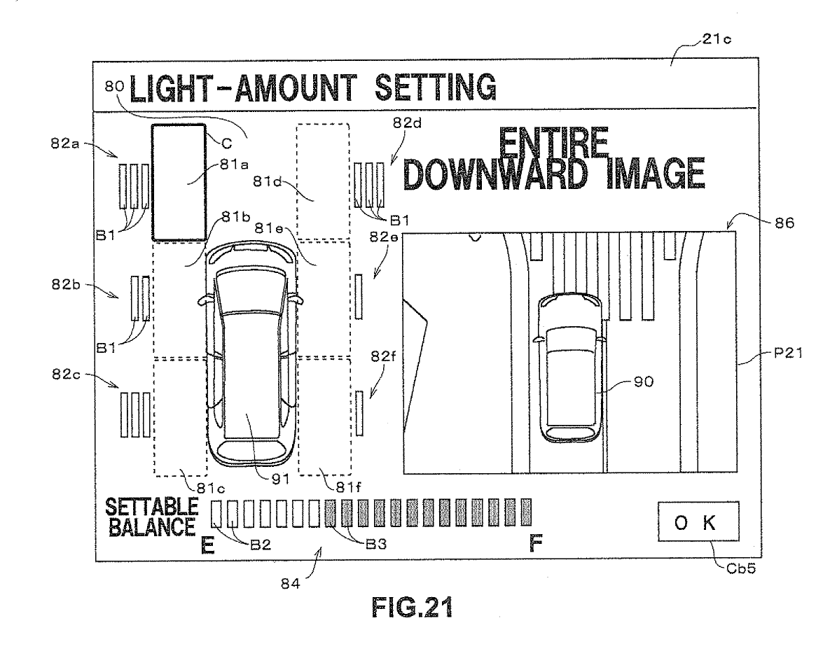

FIG. 21 is an enlarged diagram showing the change screen 21c corresponding to the entire downward image P21. In a case of the change screen 21c, the command buttons Cb11 to Cb13 for changing the types of the vehicle surrounding image to be displayed are not provided, unlike FIG. 13. As for the rest, the change screen 21c is the same as the change screen 21a explained in FIG. 13, and the user can change the light-amount parameters in a similar operation cited to explain FIG. 13.

When the change screen 21c is displayed, the parameter set St corresponding to the entire downward image P21 is acquired, and the light amounts of the six light sources 61a to 61f are individually adjusted by the control of the lighting control part 12 based on the six light-amount parameters included in the parameter set St. The values of the six light-amount parameters included in the parameter set St are respectively displayed in the parameter display regions 82a to 82f. Moreover, when the user presses an OK button Cb5, a change of the six light-amount parameters included in the parameter set St corresponding to the entire downward image P21 is determined.

The styles of the change screens 21d and 21e (refer to FIG. 20) are the same as the change screen 21c except the vehicle surrounding image displayed in an image display region 86.

When the change screen 21d corresponding to the behind downward image P22 is displayed, the parameter set St corresponding to the behind downward image P22 is acquired. Based on the parameter set St acquired, the light amounts of the six light sources 61a to 61f are adjusted. Moreover, when the user presses an OK button Cb5 on the change screen 21d, a change of the six light-amount parameters included in the parameter set St corresponding to the behind downward image P22 is determined.

When the change screen 21e corresponding to the side image P23 is displayed, the parameter set St corresponding to the side image P23 is acquired. Based on the parameter set St acquired, the light amounts of the six light sources 61a to 61f are adjusted. Moreover, when the user presses an OK button Cb5 on the change screen 21e, a change of the six light-amount parameters included in the parameter set St corresponding to the side image P23 is determined.

### 2-4. Individual Setting Modes

In the second embodiment, besides the light-amount setting mode M3, individual setting modes for changing the light-amount parameters are provided. The image display mode M2 where the vehicle surrounding image is displayed can be changed to each of the individual setting modes by an easy operation.

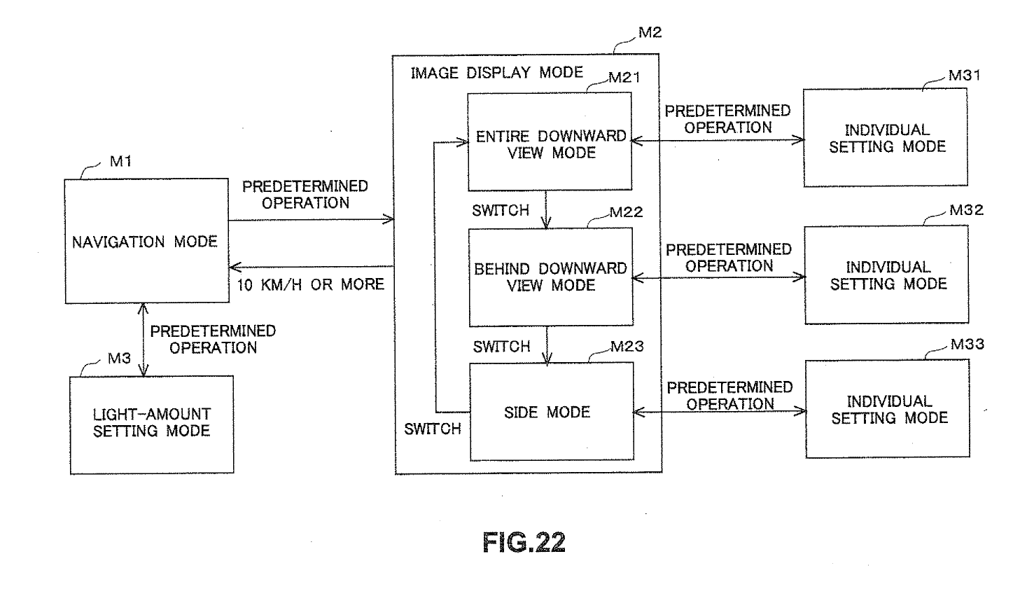

FIG. 22 shows transitions of operation modes in the second embodiment. As shown in the drawing, the transition to the navigation mode M1, the image display mode M2 and the light-amount setting mode M3 are the same as the transition explained in the first embodiment. However, when a predetermined operation is performed in one of the display modes M21 to M23 of the image display mode M2, the screen is changed to one of individual setting modes M31 to M33 for changing the six parameters included in the parameter set St corresponding to the type of the vehicle surrounding image displayed immediately before the predetermined operation. Since the screen is changed to one of the individual setting modes M31 to M33 only by a single user operation, the user can easily change a desired parameter from amongst the six light-amount parameters according to the type of the vehicle surrounding image without performing a complicated operation.

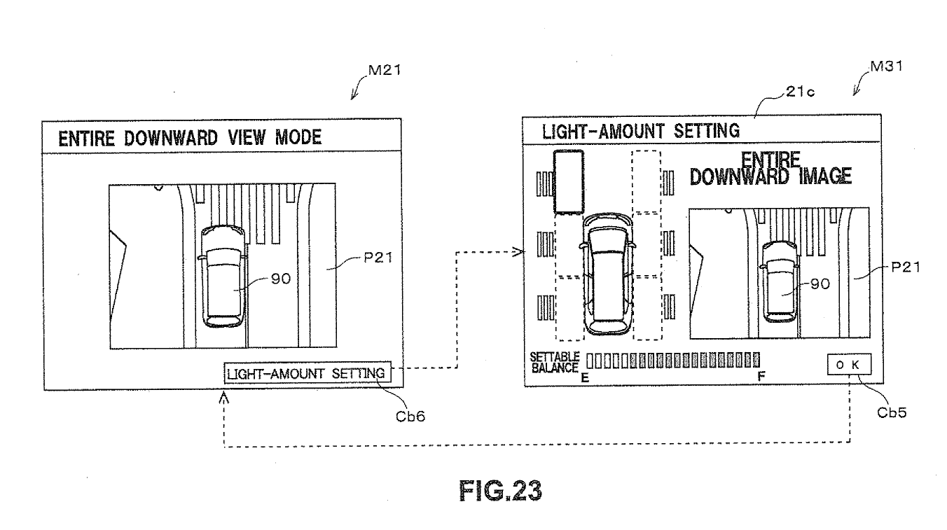

In a case of the entire downward view mode M21, as shown in FIG. 23, when the user touches a light-amount setting button Cb6 displayed on the screen of the display 21, the operation mode is changed to the individual setting mode M31. In the individual setting mode M31, the change screen 21c corresponding to the entire downward image P21 displayed until immediately before the operation, is displayed, and then the user can change the six light-amount parameters included in the parameter set St corresponding to the entire downward image P21. Then when the user touches the OK button Cb5 on the change screen 21c, the change of the six light-amount parameters is determined while the operation mode returns to the entire downward view mode M21.

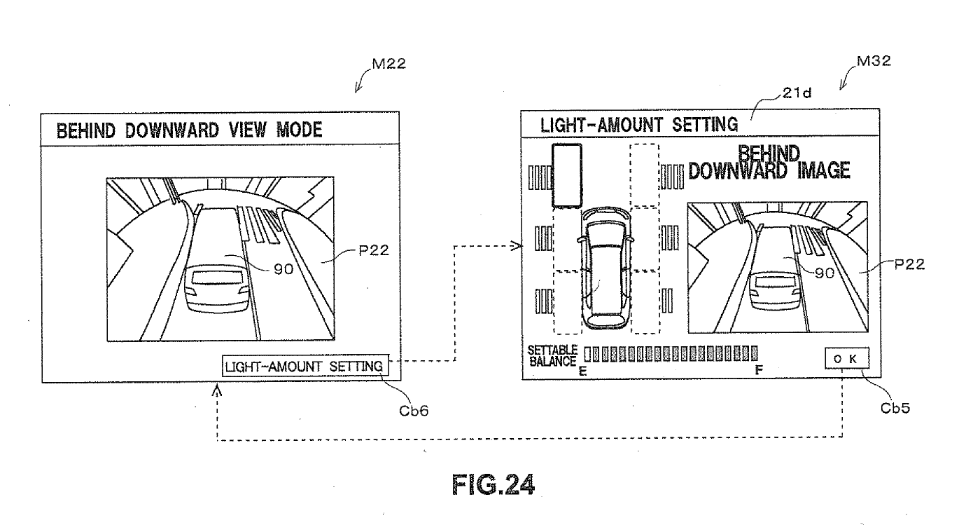

In a case of the behind downward view mode M22, as shown in FIG. 24, when the user touches a light-amount setting button Cb6 displayed on the screen of the display 21, the operation mode is changed to the individual setting mode M32. In the individual setting mode M32, the change screen 21d corresponding to the behind downward image P22 displayed immediately before the operation, is displayed, and then the user can change the six light-amount parameters included in the parameter set St corresponding to the behind downward image P22. Then when the user touches the OK button Cb5 on the change screen 21d, the change of the six light-amount parameters is determined while the operation mode returns to the behind downward view mode M22.

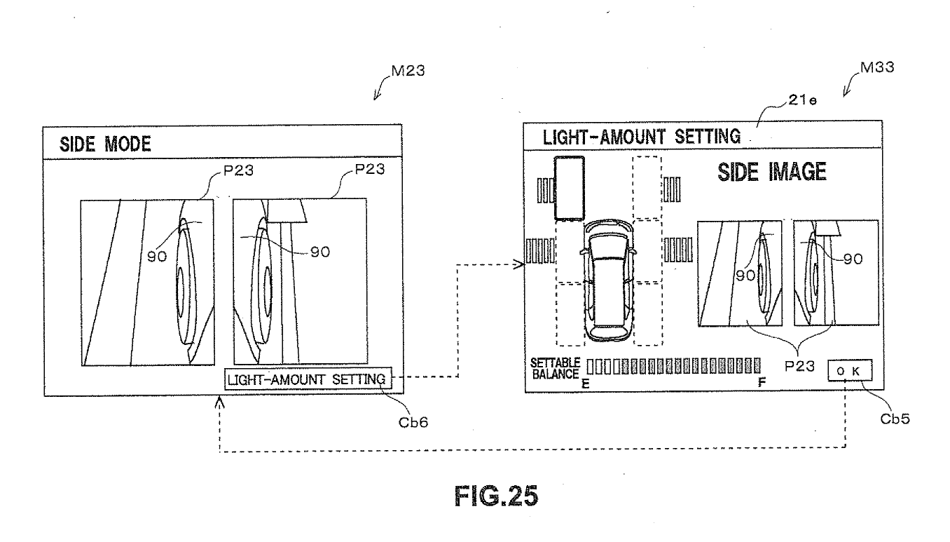

In a case of the side mode M23, as shown in FIG. 25, when the user touches a light-amount setting button Cb6 displayed on the screen of the display 21, the operation mode is changed to the individual setting mode M33. In the individual setting mode M33, the change screen 21e corresponding to the side image P23 displayed immediately before the operation, is displayed, and then the user can change the six light-amount parameters included in the parameter set St corresponding to the side image P23. Then when the user touches the OK button Cb5 on the change screen 21e, the change of the six light-amount parameters is determined while the operation mode returns to the side mode M23.

Therefore, in other words, when one of the individual setting modes M31 to M33 is used, an operation of changing a display mode in the image display mode M2 is equivalent to a user operation of designating a type of the vehicle surrounding image of which the parameter set St is to be changed.

As described above, in the second embodiment, since the light-amount parameters can be changed for each type of the vehicle surrounding image, the light amount to be output by each of the light sources 61a to 61f can be set to an appropriate amount according to the viewpoint of the vehicle surrounding image. A region to which the user pays attention differs according to type of the vehicle surrounding image displayed on the display 21. In this embodiment, it is possible to adjust the light amounts, such as increasing the light amounts, of the light sources illuminating a region to which the user pays attention according to the type of the vehicle surrounding image.

### 3. Third Embodiment

Next, a third embodiment is described. All the light-amount parameters can be changed in the second embodiment. On the other hand, in the third embodiment, a part of the light-amount parameters cannot be changed when a particular type from amongst a plurality of types of the vehicle surrounding image is designated. A structure and an operational process of an image display system 120 in the third embodiment are approximately same as the structure and the operational process of the image display system 120 in the second embodiment. Therefore, hereinbelow, a difference from the second embodiment is described.

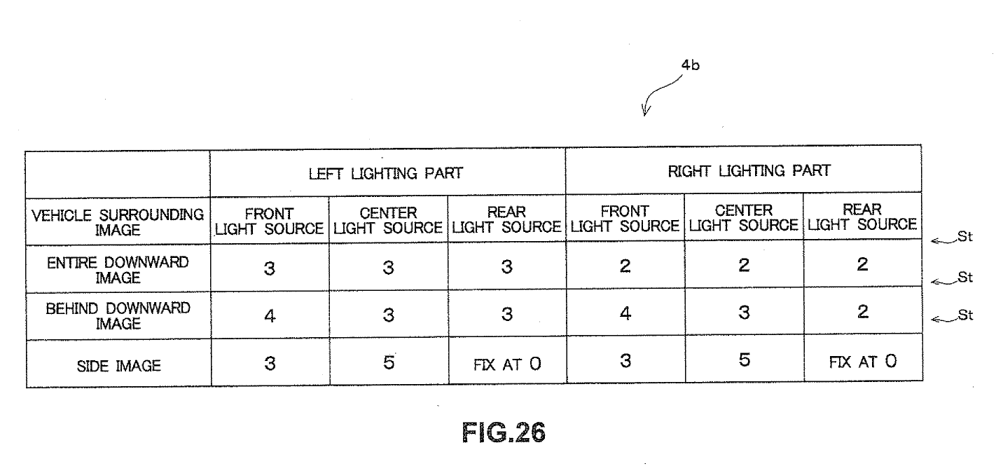

FIG. 26 shows an example of light-amount setting data 4b in the third embodiment. As shown in FIG. 26, the light-amount parameters for rear light sources 61c and 61f are indicated as “fixed at zero” in a parameter set St corresponding to side images P23.

Rear regions BA (refer to FIG. 4) illuminated by the rear light sources 61c and 61f are not included in the side images P23 as subject images. Therefore, even if the rear regions BA are illuminated in a case where the side images P23 are displayed, the illumination has no effect on contents displayed on a display 21 and the electricity is only wasted.

Therefore, in this embodiment, a user cannot change a light-amount parameter of a light source that illuminates a divided region not included in the vehicle surrounding image as a subject image. At the same time, the light-amount parameter of the light source is fixed at “zero” to make the light amount output by the light source zero (to turn off the light source).

Such a light-amount parameter to be fixed at “zero,” as shown in FIG. 26, is indicated as “fixed at zero” in the light-amount setting data 4b. When the light-amount parameter indicated as “fixed at zero” is acquired in an image display mode M2, the light amount output by the light source corresponding to the light-amount parameter is made to be zero. (In other words, the light source is turned off.) As a result, a divided region not requiring illumination from a viewpoint of the vehicle surrounding image is not uselessly illuminated and the electricity consumption can be reduced.

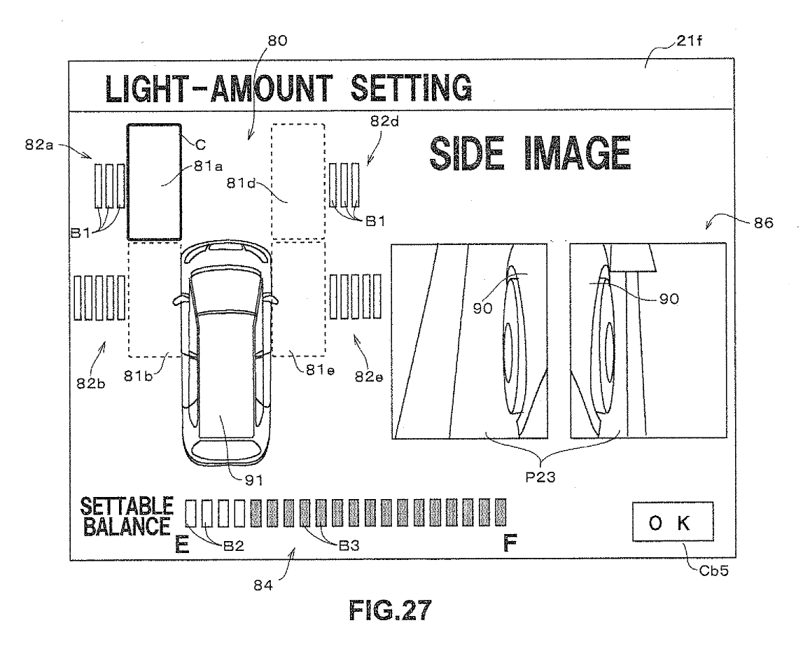

FIG. 27 show an example of a change screen 21f corresponding to the side image P23 in the third embodiment. On the change screen 21f, display divided regions corresponding to rear regions BA on right and left sides are not displayed in a light amount-setting region 80. As a result, rear regions BA cannot be selected as divided regions for which light-amount parameters are changed. Accordingly, the light-amount parameters of the light sources 61c and 61f that illuminate the rear regions BA are unable to be changed.

When the user touches an OK button Cb5, a changed value of the light-amount parameter is determined. However, a value of the light-amount parameter to be fixed at “zero” remains fixed at “zero.”

As described above, in the third embodiment, when the user designates the particular type (the side images P23) as a type of the vehicle surrounding image of which the parameter set St is to be changed, a part of the light-amount parameters cannot be changed. Therefore, it is possible to change a light amount output by only a light source relating to a divided region requiring illumination from the viewpoint of the particular type of the vehicle surrounding image.

### 4. Modification

As described above, the embodiments of the invention are cited. However, the invention is not limited to the aforementioned embodiments, but a variety of modifications are possible. Examples of such modifications are hereinbelow described. All embodiments including the embodiments described above and the modifications described below can be optionally combined.

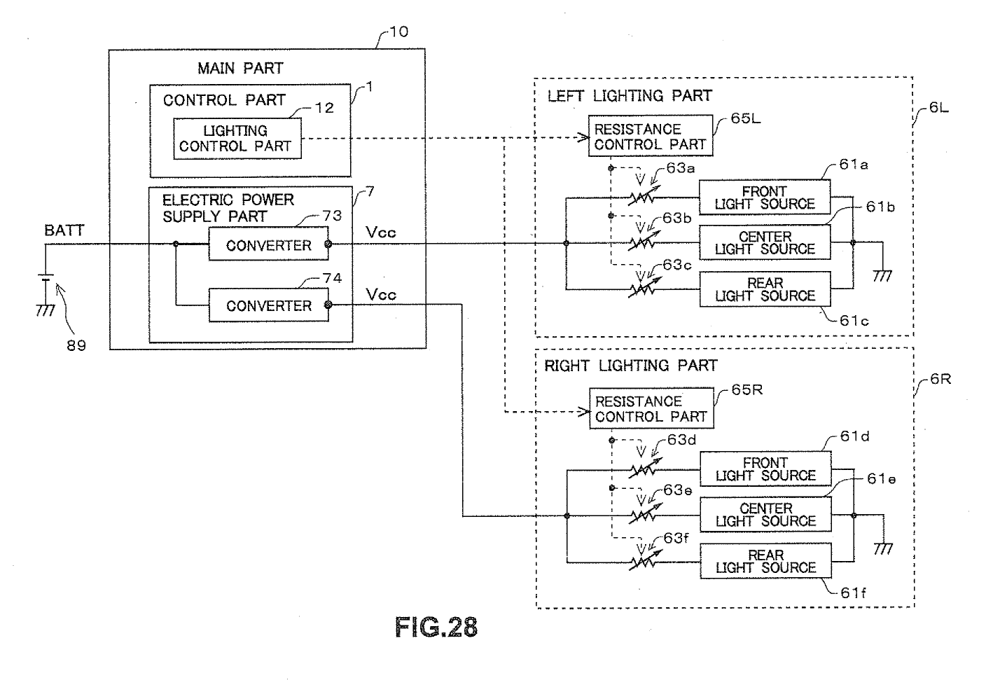

In the aforementioned embodiments, the light sources 61a to 61c of the left lighting part 6L and the light sources 61d to 61f of the right lighting part 6R are supplied with electric power from the converter 71 in common. On the other hand, as shown in FIG. 28, a converter 73 may be provided to supply electric power to light sources 61a to 61c of a left lighting part 6L, and a converter 74 may be provided to supply electric power to light sources 61d to 61f of a right lighting part 6R. In this case, an upper limit is set for a total light amount output by the light sources 61a to 61c of the left lighting part 6L, separately from an upper limit for a total light amount output by the light sources 61d to 61f of the right lighting part 6R.

Moreover, in the aforementioned embodiments, the display divided regions 81a to 81f are displayed along with the vehicle illustration 91 in the change screen for changing the light-amount parameters. On the other hand, a composite image, such as an entire downward image, may be displayed, and display divided regions 81a to 81f may be displayed in the composite image. In this case, positions of actual divided regions may be displayed relative to the vehicle 9 based on positions of the display divided regions 81a to 81f relative to the vehicle image 90 included in the composite image. Furthermore, in this case, it is possible to superimpose brightness of each of the actual divided regions on the display divided regions 81a to 81f by using the composite image acquired in substantially real time.

In addition, in the aforementioned embodiments, the value of each of the light-amount parameters corresponding to each of the divided regions is shown by the number of bars of the level-setting bar set B1. However, the value may be indicated in another method such as by color and in a numerical value. Moreover, an amount by which the light-amount parameters can be changed until a total light amount to be output by the light sources reaches the upper limit, may also be indicated in another method, such as in a numerical value.

In the aforementioned embodiments, the side regions of the vehicle are set as particular regions around the vehicle that a plurality of light sources illuminate. However, the particular regions are not limited to the side regions of the vehicle, and a region around the vehicle may be optionally set as a particular region. However, setting the side regions of the vehicle as the particular regions, as in the embodiments described above, is effective because an image showing the side regions that are difficult for a driver to see and that are difficult to be illuminated by a lighting system for driving, such as headlights, can be displayed even when the surroundings around the vehicle are dark. In the embodiments described above, the side regions on the both right and left sides are set as the particular regions. However, only one of the side regions (for example, only a side region that is opposite side to the driver seat and that is particularly likely to be a blind spot from the driver) may be set a particular region.

In the aforementioned embodiments, it is explained that the image processing apparatus 100 is separated from the navigation apparatus 20. However, the image processing apparatus 100 and the navigation apparatus 20 may be disposed in the same single housing as a combined apparatus.

In the aforementioned embodiments, it is explained that an image generated by the image processing apparatus 100 is displayed on the display of the navigation apparatus 20. However, the image may be displayed on a common display unit that does not have a special function such as a navigation function.

A part of functions implemented by the controller 1 of the image processing apparatus 100 in the aforementioned embodiments may be implemented by the control part 23 of the navigation apparatus 20.

In addition, a part or all of the signals input into the controller 1 of the image processing apparatus 100 via the signal receiver 41 in the aforementioned embodiments may be input into the navigation apparatus 20. In this case, the signals may be input into the controller 1 of the image generation processing 100 via the navigation communication part 42.

Moreover, in the aforementioned embodiments, it is explained that various functions are implemented by software performance by arithmetic processing of a CPU in accordance with a program. However, a part of these functions may be implemented by electric hardware circuitry. Contrarily, a part of the functions implemented by electric hardware circuitry in the aforementioned embodiments may be implemented by software.

While the invention has been shown and described in detail, the foregoing description is in all aspects illustrative and not restrictive. It is therefore understood that numerous other modifications and variations can be devised without departing from the scope of the invention.

What is claimed is:

1. An image display system comprising:
a display that displays a vehicle surrounding image showing surroundings of a vehicle based on a shot image acquired by shooting the surroundings of the vehicle with a camera;
a plurality of light sources that assist the camera in shooting by respectively illuminating a plurality of divided regions into which a region of the surroundings of the vehicle is divided; and
a controller that (i) based on input from a user, individually changes each of a plurality of parameters respectively specifying an amount of light to be output by each of the plurality of light sources, and (ii) adjusts the amount of light output by each of the plurality of light sources based on the plurality of parameters.

2. The image display system according to claim 1, wherein
the controller, based on the input from the user, selects one divided region from amongst the plurality of divided regions, and changes a parameter of the plurality of parameters for a light source illuminating the one divided region selected from amongst the plurality of light sources.

3. The image display system according to claim 2, wherein
the display displays positions of the plurality of divided regions relative to the vehicle on a screen used to select the one divided region.

4. The image display system according to claim 3, wherein
the display adjusts the positions of the plurality of divided regions relative to the vehicle, in accordance with a type of the vehicle.

5. The image display system according to claim 1, further comprising
an image generator that generates a composite image showing the surroundings of the vehicle viewed from a virtual viewpoint, based on a plurality of the shot images acquired by shooting the surroundings of the vehicle with a plurality of the cameras, wherein
the vehicle surrounding image includes the composite image.

6. The image display system according to claim 1, wherein,
in response to changes of the plurality of parameters, the controller adjusts the amounts of light output by the plurality of light sources based on the plurality of parameters changed, and
the display displays the vehicle surrounding image showing the surroundings of the vehicle shot in substantially real time using the adjusted amounts of the light output by the plurality of light sources, on a change screen used to change the plurality of parameters.

7. The image display system according to claim 6, wherein
the controller changes, based on the input of the user, a type of the vehicle surrounding image to be displayed on the change screen, from amongst a plurality of the types of the vehicle surrounding images which have different viewpoints relative to each other.

8. The image display system according to claim 1, wherein
the controller changes, based on the input of the user, a type of the vehicle surrounding image to be displayed on the display, from amongst a plurality of the types of the vehicle surrounding images which have different viewpoints relative to each other.

9. The image display system according to claim 8, further comprising
a memory that stores a set of the plurality of parameters respectively specifying the amounts of light to be output by the plurality of light sources, for each of the plurality of types of the vehicle surrounding images, wherein
the controller changes the plurality of parameters included in the set corresponding to one type of the vehicle surrounding image designated by the user, from amongst the plurality of types of the vehicle surrounding images.

10. The image display system according to claim 9, wherein,
in response to a change of the type of the vehicle surrounding image, the controller adjusts each of the amounts of light output by each of the plurality of light sources based on the plurality of parameters included in the set corresponding to the type of the vehicle surrounding image being displayed after the change.

11. The image display system according to claim 9, wherein
the display displays, in response to a single operation by the user in a state where the vehicle surrounding image is displayed, a change screen used to change the plurality of parameters included in the set corresponding to a type of the vehicle surrounding image being displayed immediately before the single operation.

12. The image display system according to claim 9, wherein
the controller does not allow a change of a part of the plurality of parameters in a case where the one type of the vehicle surrounding image designated by the user, from amongst the plurality of types of the vehicle surrounding images, is a predetermined type.

13. The image display system according to claim 12, wherein
the controller does not allow a change of the parameter for a light source among the plurality of light sources, which illuminates one of the divided regions which is not included as a subject image in the predetermined type of the vehicle surrounding image.

14. The image display system according to claim 13, wherein
the parameter not allowed to be changed is fixed at a value which sets an amount of light to be output by the light source to zero.

15. The image display system according to claim 1, further comprising
an electric power supply part that supplies electric power to the plurality of light sources via a common output terminal, wherein
when a total amount of light output by the plurality of light sources would exceed a predetermined amount of light, which is set based on a capability of the electric power supply part, due to a change in the plurality of parameters based on the input from the user, the controller does not change the plurality of parameters.

16. The image display system according to claim 15, further comprising
an alarm that provides the user with a warning when the total amount of light to be output by the plurality of light sources would exceed the predetermined amount of light due to a change in the plurality of parameters based on the input by the user.

17. The image display system according to claim 15, wherein
the display displays an amount by which the plurality of parameters can be changed until the total amount of light to be output by the plurality of light sources reaches the predetermined amount of light, on a change screen used to change the plurality of parameters.

18. An image display system comprising:
a display that displays a vehicle surrounding image showing surroundings of a vehicle based on a shot image acquired by shooting the surroundings of the vehicle with a camera;
a plurality of light sources that assist the camera in shooting; and
a controller that (i) based on input from a user, selects one region from amongst a plurality of regions that comprise the surroundings of the vehicle, and (ii) adjusts an amount of light output by a light source illuminating the one region from amongst the plurality of light sources.

19. An image display method comprising:
(a) displaying a vehicle surrounding image showing surroundings of a vehicle based on a shot image acquired by shooting the surroundings of the vehicle with a camera;
(b) respectively illuminating a plurality of divided regions into which a region of the surroundings of the vehicle is divided, with a plurality of light sources, to assist the camera in shooting;
(c) based on input from a user, individually changing each of a plurality of parameters respectively specifying amounts of light to be output by each of the plurality of light sources; and
(d) adjusting the amount of light output by each of the plurality of light sources based on the plurality of parameters.

20. An image display method comprising:
(a) displaying a vehicle surrounding image showing surroundings of a vehicle based on a shot image acquired by shooting the surroundings of the vehicle with a camera;
(b) based on input from a user, selecting one region from amongst a plurality of regions that comprise the surroundings of the vehicle; and
(c) adjusting an amount of light output by a light source illuminating the one region from amongst a plurality of light sources assisting the camera in the shooting.
